(19) United States
(12) Patent Application Publication
(10) Pub. No.: US 2025/0373850 A1
(43) Pub. Date: Dec. 4, 2025

(54) 3D DATA TRANSMISSION DEVICE, 3D DATA TRANSMISSION METHOD, 3D DATA RECEPTION DEVICE, AND 3D DATA RECEPTION METHOD

(71) Applicant: LG Electronics Inc., Seoul (KR)

(72) Inventors: Hanje PARK, Seoul (KR); Joohyung BYEON, Seoul (KR); Naseong KWON, Seoul (KR); Donggyu SIM, Seoul (KR)

(21) Appl. No.: 19/107,262

(22) PCT Filed: Aug. 30, 2023
(86) PCT No.: PCT/KR2023/012878

§ 371 Date: Feb. 27, 2025

(30) Foreign Application Priority Data
Aug. 30, 2022 (KR) 10-2022-0109173

(51) Int. Cl. H04N 19/597; G06T 17/20; H04N 19/119; H04N 19/139

(52) U.S. Cl. CPC H04N 19/597; G06T 17/20; H04N 19/119; H04N 19/139

(57) ABSTRACT

A 3D data transmission method according to embodiments may comprise the steps of: pre-processing input mesh data and outputting base mesh data; encoding the base mesh data; and transmitting a bit-stream including the encoded mesh data and signaling information.

### DESCRIPTION

### Technical Field

Embodiments provide a method for providing 3D content to provide a user with various services such as virtual reality (VR), augmented reality (AR), mixed reality (MR), and self-driving services.

### Background Art

Point cloud data or mesh data in 3D content is a set of points in 3D space. However, it is difficult to create point cloud data or mesh data due to the large amount of points in 3D space.

In other words, a large throughput is required to transmit and receive 3D data with a considerable number of points, such as a point cloud or mesh data.

### DISCLOSURE

### Technical Problem

An object of the present disclosure is to provide an apparatus and method for efficiently transmitting and receiving mesh data to resolve the aforementioned issue.

Another object of the present disclosure is to provide an apparatus and method to address the latency and encoding/decoding complexity of mesh data.

Embodiments are not limited to the above-described objects, and the scope of the embodiments may be extended to other objects that can be inferred by those skilled in the art based on the entire contents of the present disclosure.

### Technical Solution

To achieve these objects and other advantages and in accordance with the purpose of the invention, as embodied and broadly described herein, a method of transmitting three-dimensional (3D) data may include pre-processing input mesh data and outputting base mesh data, encoding the base mesh data, and transmitting a bitstream including the encoded mesh data and signaling information.

According to embodiments, the encoding of the base mesh data may include partitioning reference base mesh data into subgroups, acquiring a motion vector between the base mesh data and the reference base mesh data for each of the subgroups, and encoding the acquired motion vector.

According to embodiments, the motion vector is an average of motion vectors of vertices in a corresponding one of the subgroups.

According to embodiments, the signaling information may include information related to the subgroup partitioning.

According to embodiments, the signaling information further may include motion vector-related information for indicating whether to skip the motion vector.

According to embodiments, the method may further include transmitting the motion vector or skipping the transmission of the motion vector based on the motion vector-related information.

According to embodiments, based on the transmission of the motion vector being skipped, a zero vector may be derived for the motion vector on a receiving side.

According to embodiments, a device for transmitting 3D data may include a pre-processor configured to pre-process input mesh data and output base mesh data, an encoder configured to encode the base mesh data, and a transmitter configured to transmit a bitstream including the encoded mesh data and signaling information.

According to embodiments, the encoder may include a subgroup partitioner configured to partition reference base mesh data into subgroups, a motion vector calculator configured to acquire a motion vector between the base mesh data and the reference base mesh data for each of the subgroups, and an encoder configured to entropy-encode the acquired motion vector.

According to embodiments, the motion vector is an average of motion vectors of vertices in a corresponding one of the subgroups.

According to embodiments, the signaling information may include information related to the subgroup partitioning.

According to embodiments, the signaling information further may include motion vector-related information for indicating whether to skip the motion vector.

According to embodiments, the motion vector may be transmitted or the transmission of the motion vector may be skipped based on the motion vector-related information.

According to embodiments, based on the transmission of the motion vector being skipped, a zero vector may be derived for the motion vector on a receiving side.

According to embodiments, a method of receiving 3D data may include receiving a bitstream containing encoded mesh data and signaling information, decoding the mesh data based on a motion vector for each of the subgroups, and rendering the decoded mesh data.

### Advantageous Effects

According to embodiments, a 3D data transmission method, 3D data transmission device, 3D data reception method, and 3D data reception device may provide good-quality 3D services.

According to embodiments, a 3D data transmission method, 3D data transmission device, 3D data reception method, and 3D data reception device may achieve various video codec schemes.

According to embodiments, a 3D data transmission method, 3D data transmission device, 3D data reception method, and 3D data reception device may support universal 3D content, such as for autonomous driving services.

According to embodiments, when encoding/decoding geometry information related to 3D dynamic mesh data through inter-frame prediction, a 3D data transmission method, 3D data transmission device, 3D data reception method, and 3D data reception device may partition a reference base mesh into subgroups, and calculate motion vectors on a per-subgroup basis, such that (difference) motion vectors may be transmitted on a per-subgroup basis. Thereby, the amount of data to be transmitted may be reduced, and the compression efficiency of the geometry information may be increased.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts. In the drawings:

FIG. 1 illustrates a system for providing dynamic mesh content according to embodiments;

FIG. 2 illustrates a V-MESH compression method according to embodiments;

FIG. 3 illustrates pre-processing in V-MESH compression according to embodiments;

FIG. 4 illustrates a mid-edge subdivision method according to embodiments;

FIG. 5 illustrates a displacement generation process according to embodiments;

FIG. 6 illustrates an intra-frame encoding process for V-MESH data according to embodiments;

FIG. 7 illustrates an inter-frame encoding process for V-MESH data according to embodiments;

FIG. 8 illustrates a lifting transform process for displacements according to embodiments;

FIG. 9 illustrates a process of packing transform coefficients into a 2D image according to embodiments;

FIG. 10 illustrates an attribute transfer process in a V-MESH compression method according to embodiments;

FIG. 11 illustrates an intra-frame decoding process for V-MESH data according to embodiments;

FIG. 12 illustrates an inter-frame decoding process for V-MESH data according to embodiments;

FIG. 13 illustrates a mesh data transmission apparatus according to embodiments;

FIG. 14 illustrates a mesh data reception apparatus according to embodiments;

FIG. 15 illustrates a mesh data transmission device according to embodiments;

FIG. 16 is an exemplary detailed block diagram of a motion vector encoder according to embodiments;

FIG. 17 is a diagram illustrating an example of the process of checking whether to skip a motion vector and calculating a motion vector according to the embodiments;

FIG. 18 illustrates an example of an N-th patch in texture space according to embodiments;

FIG. 19 shows examples of motion vector resolutions according to motion vector resolution information according to the embodiments;

FIG. 20 is a diagram illustrating an example of motion vector resolution on a per-subgroup basis in an octree structure according to embodiments;

FIG. 21 illustrates a mesh data reception device according to embodiments;

FIG. 22 is a diagram illustrating an exemplary subgroup partition process according to embodiments;

FIG. 23 shows examples of a subgroup partitioning method index according to embodiments;

FIG. 24 is a diagram illustrating an example of deriving subgroup partitioning information from an octree structure according to embodiments;

FIG. 25 is an exemplary detailed block diagram of a motion vector decoder according to embodiments;

FIG. 26 is a diagram illustrating an example detailed operation of a difference motion vector decoder according to embodiments;

FIG. 27 is a diagram illustrating an exemplary motion vector estimation process according to embodiments;

FIG. 28 shows an exemplary syntax structure of subgroup partitioning information according to embodiments;

FIG. 29 shows an exemplary syntax structure of motion vector related information according to embodiments;

FIG. 30 is a flowchart illustrating an exemplary transmission method according to embodiments; and

FIG. 31 is a flowchart illustrating an exemplary reception method according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

With recent advancements in 3D data modeling and rendering technologies, research on generating and processing 3D data has been actively conducted across various fields, including virtual reality (VR), augmented reality (AR), autonomous driving, computer-aided design (CAD)/computer-aided manufacturing (CAM), and geographic information systems (GIS). 3D data may be represented as a point cloud or a mesh depending on the representation format. A mesh is composed of geometry information indicating the coordinates of each vertex or point, connectivity information indicating connections between vertices, a texture map representing color information about the mesh surface as 2D image data, and texture coordinates indicating the mapping information between the surface of the mesh and the texture map. In the present disclosure, a mesh is defined as a dynamic mesh when at least one of the elements constituting the mesh changes over time, and is defined as a static mesh when it does not change.

Dynamic mesh data involves significantly larger amounts of data of elements to represent the mesh compared to 2D image data. As a result, techniques for efficiently compressing a large amount of mesh data have been developed to store and transmit the data.

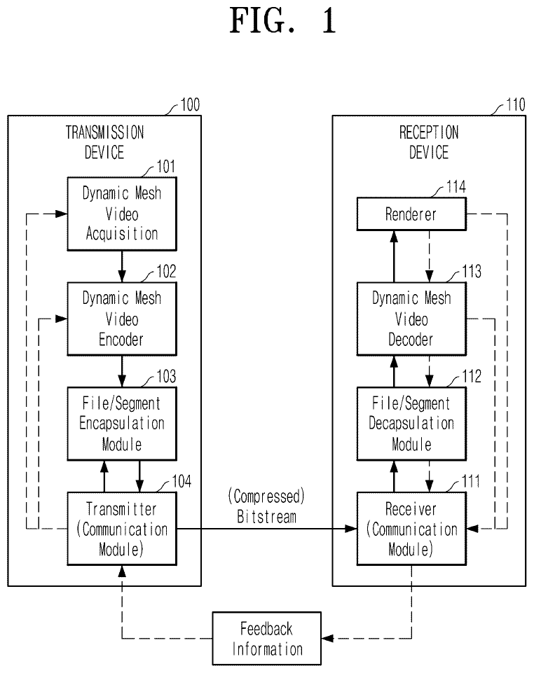

FIG. 1 illustrates a system for providing dynamic mesh content according to embodiments.

The system in FIG. 1 includes a transmission apparatus 100 and a reception apparatus 110. The transmission apparatus 100 may include a mesh video acquisition unit (or part) 101, a mesh video encoder 102, a file/segment encapsulator 103, and a transmitter 104. The reception apparatus 110 may include a receiver 111, a file/segment decapsulator 112, a mesh video decoder 113, and a renderer 114. Each component in FIG. 1 may correspond to hardware, software, a processor, and/or a combination thereof. In the following description, a mesh data transmission apparatus according to embodiments may be interpreted as referring to a 3D data transmission apparatus or transmission apparatus 100, or as referring to a mesh video encoder (hereinafter, encoder) 102. A mesh data reception apparatus according to embodiments may be interpreted as referring to a 3D data reception apparatus or reception apparatus 110, or as referring to a mesh video decoder (hereinafter, decoder) 113.

The system of FIG. 1 may perform video-based dynamic mesh compression and decompression.

With advancements in 3D capture, modeling, and rendering, users are allowed to access 3D content in various forms, such as AR, XR, metaverse, and holograms, across multiple platforms and devices. 3D content is increasingly becoming sophisticated and realistic in its representation of objects to provide immersive experiences for users. However, this requires a substantial amount of data for generation and use of 3D models. Among the various types of 3D content, 3D meshes are widely used for efficient data utilization and realistic object representation. Embodiments include a series of processing steps in a system that uses mesh content.

First, the method of compressing dynamic mesh data starts with the Video-based point cloud compression (V-PCC) standard technique for point cloud data. Point cloud data is data that has color information in the coordinates (X, Y, Z) of vertices (or points). In the present disclosure, vertex coordinates (i.e., position information) are referred to as geometry information, color information about vertices is referred to as attribute information. The geometry information and attribute information are together referred to as vertex information or point cloud data. Mesh data refers to vertex information including inter-vertex connectivity information. Content may be originally created in the form of mesh data. Alternatively, connectivity information may be added to point cloud data, and the point cloud data may be transformed into mesh data.

Currently, the MPEG standards group defines two data types for dynamic mesh data: Category 1 of mesh data having a texture map as color information, and Category 2 of mesh data having vertex colors as color information.

Mesh coding standards for Category 1 data are currently underway, and standardization for Category 2 data is expected to follow. The overall process for providing a mesh content service may include acquisition, encoding, transmission, decoding, rendering, and/or feedback processes, as shown in FIG. 1.

To provide mesh content services, 3D data acquired through multiple cameras or special cameras may be processed into a mesh data type through a series of steps to generate a video. The generated mesh video may be transmitted through a series of operations, and the receiving side may process the received data back into a mesh video for rendering. Through this process, the mesh video may be provided to the user, allowing the user to utilize the mesh content interactively according to their intent.

As shown in FIG. 1, a mesh compression system may include a transmission apparatus 100 and a reception apparatus 110. The transmission apparatus 100 may encode the mesh video to output a bitstream, which may be delivered to the reception apparatus 110 over a digital storage medium or a network in the form of file or streaming (streaming segments). The digital storage medium may include various storage media such as USB, SD, CD, DVD, Blu-ray, HDD, and SSD.

In the transmission apparatus 100, the encoder may be referred to as a mesh video/image/picture/frame encoding device. In the reception apparatus 110, the decoder may be referred to as a mesh video/image/picture/frame decoding device. A transmitter may be included in the mesh video encoder, and a receiver may be included in the mesh video decoder. The renderer 114 may include a display, and the renderer and/or display may be configured as separate devices or external components. The transmission apparatus 100 and reception apparatus 110 may further include separate internal or external modules/units/components for the feedback process.

Mesh data represents the surface of an object using multiple polygons. Each polygon is defined by vertices in 3D space and connectivity information indicating how the vertices are connected. Additionally, vertex attributes such as color and normal vectors may be included in the data. Mapping information, which allows the surface of the mesh to be mapped onto a 2D plane, may also be included in the attributes of the mesh. The mapping is generally described using a set of parametric coordinate related to mesh vertices, referred to as UV coordinates or texture coordinates, related to related to the vertices of the mesh. A mesh contains a 2D attribute map, which may be used to store high-resolution attribute information such as texture, normal, and displacement. Here, the displacement may be used interchangeably with displacement information or a displacement vector.

The mesh video acquisition unit 101 may include processing 3D object data acquired through a camera or the like into a mesh data type having the attributes described above through a series of operations and generating a video composed of the mesh data. In the mesh video, the attributes of the mesh, such as vertices, polygons, connectivity between vertices, color, and normal, may change over time. A mesh video with attributes and connectivity information that change over time is referred to as a dynamic mesh video.

The mesh video encoder 102 may encode an input mesh video into one or more video streams. A video may contain multiple frames, each of which may correspond to a still image/picture. In the present disclosure, the mesh video may include mesh images/frames/pictures. The term “mesh video” may be used interchangeably with mesh images/frames/pictures. The mesh video encoder 102 may perform a Video-based Dynamic Mesh (V-Mesh) compression procedure. For compression and coding efficiency, the mesh video encoder 102 may perform a series of procedures such as prediction, transformation, quantization, and entropy coding. Encoded data (encoded video/image information) may be output in the form of a bitstream.

The file/segment encapsulation module 103 may encapsulate encoded mesh video data and/or mesh video-related metadata in the form of a file or the like. The mesh video-related metadata may be received from a metadata processor. The metadata processing unit may be included in the mesh video encoder 102, or may be configured as a separate component/module. The file/segment encapsulation module 103 may encapsulate the data into a file format such as ISOBMFF or process the same into forms such as DASH segments. According to embodiments, the file/segment encapsulator 103 may include the mesh video-related metadata in the file format. For example, the mesh video metadata may be included in boxes at various levels in the ISOBMFF file format, or as data on separate tracks in the file. In some embodiments, the file/segment encapsulator 103 may encapsulate the mesh video-related metadata into a file.

The transmission processor may apply processing to the encapsulated mesh video data for transmission based on the file format. The transmission processor may be included in the transmitter 104 or implemented as a separate component/module. The transmission processor may process the mesh video data according to any transmission protocol. The processing for transmission may include processing for delivery over a broadcast network and processing for delivery over a broadband. In some embodiments, the transmission processor may receive mesh video-related metadata from the metadata processor, as well as the mesh video data, and process the same for transmission.

The transmitter 104 may transmit the encoded video/image information or data output in bitstream form to the receiver 111 of the reception apparatus 110 over a digital storage medium or network in the form of a file or streaming. The digital storage medium may include various storage media such as USB, SD, CD, DVD, Blu-ray, HDD, and SSD. The transmitter 104 may include an element to generate a media file through a predetermined file format, and may include an element for transmission over a broadcast/communication network. The receiver 111 may extract the bitstream and deliver the same to a decoding device.

The receiver 111 may receive the mesh video data transmitted by the mesh data transmission apparatus. Depending on the channel for transmission, the receiver 111 may receive the mesh video data over a broadcast network or a broadband network, or may receive the mesh video data over a digital storage medium.

The reception processor may perform processing on the received mesh video data according to the transmission protocol. The reception processor may be included in the receiver 111, or may be configured as a separate component/module. To correspond to the processing performed for transmission on the transmitting side, the reception processor may perform the reverse process to the operations of the transmission processor described above. The reception processor may deliver the acquired mesh video data to the file/segment decapsulator 112 and the acquired mesh video-related metadata to the metadata parser. The mesh video-related metadata acquired by the reception processor may be in the form of a signaling table.

The file/segment decapsulator 112 may decapsulate mesh video data in the form of files received from the reception processor. The file/segment decapsulator 112 may decapsulate the files according to ISOBMFF or the like to acquire a mesh video bitstream or mesh video-related metadata (metadata bitstream). The acquired mesh video bitstream may be delivered to the mesh video decoder 113, and the acquired mesh video-related metadata (metadata bitstream) may be delivered to the metadata processor. The mesh video bitstream may include metadata (metadata bitstream). The metadata processor may be included in the mesh video decoder 113, or may be configured as a separate component/module. The mesh video-related metadata acquired by the file/segment decapsulator 112 may be in the form of boxes or tracks in the file format. The file/segment decapsulator 112 may receive metadata required for decapsulation from the metadata processor, when necessary. The mesh video-related metadata may be delivered to the mesh video decoder 113 for use in the mesh video decoding procedure, or to the renderer 114 for use in the mesh video rendering procedure.

The mesh video decoder 113 may receive the input bitstream and perform the reverse operation corresponding to the operation of the mesh video encoder 102 to decode the video/images. The decoded mesh video/images may be displayed through the display of the renderer 114. The user may view all or a portion of the rendered result through a VR/AR display, a general display, or the like.

The feedback process may include transmitting various kinds of feedback information that may be acquired during the rendering/display operation to the transmitting side or to the decoder on the receiving side. The feedback process may provide interactivity in consuming the mesh video. In some embodiments, the feedback process may include transmitting head orientation information, viewport information indicative of an area the user is currently viewing, and the like. In some embodiments, the user may interact with objects implemented in the VR/AR/MR/autonomous driving environment. In this case, the information related to the interaction may be delivered to the transmitting side or service provider during the feedback process. In some embodiments, the feedback process may be skipped.

The head orientation information may refer to information about the user's head position, angle, movement, etc. Based on this information, information about the area that the user is currently viewing within the mesh video, i.e., viewport information, may be calculated.

The viewport information may be information about the area in the mesh video that the user is currently viewing. Gaze analysis may be performed based on this information to determine how the user consumes the mesh video, how long the user is looking at a particular area of the mesh video, and the like. The gaze analysis may be performed on the receiving side and the result may be delivered to the transmitting side through a feedback channel. A device, such as a VR/AR/MR display, may extract a viewport area based on the user's head position/orientation, the vertical or horizontal FOV supported by the device, etc.

In some embodiments, the feedback information described above may not only be delivered to the transmitter, but may also be consumed on the receiving side. In other words, operations such as decoding and rendering may be performed on the receiving side based on the feedback information described above. For example, based on the head orientation information and/or viewport information, only the mesh video for the area currently being viewed by the user may be preferentially decoded and rendered.

The present disclosure relates to embodiments of dynamic mesh video compression as described above. The methods/embodiments disclosed herein may be applied to the standard of Video-based Dynamic mesh compression (V-Mesh) of the Moving Picture Experts Group (MPEG) or any next-generation video/image coding standard. Dynamic mesh video compression is a method for processing mesh connectivity information and attributes that change over time. It may perform lossy and lossless compression for a variety of applications such as real-time communications, storage, free-viewpoint video, and AR/VR.

The dynamic mesh video compression method described below is based on the V-mesh method of the MPEG.

In the present disclosure, a picture/frame may generally refer to a unit that represents one image at a specific time.

A pixel or pel may refer to the smallest unit that constitutes a picture (or video). Additionally, the term “sample” may be used as a term corresponding to a pixel. A sample may generally indicate a pixel or the value of the pixel in general. It may indicate only the pixel/pixel value of the luma component, or may indicate only the pixel/pixel value of the chroma component, or may indicate only the pixel/pixel value of the depth component.

A unit may represent the basic unit of image processing. The unit may include at least one of a specific area of the picture and information related to the region. In some cases, the term unit may be used interchangeably with terms such as block or area. In general, an M×N block may include a set (or array) of samples (or a sample array) or transform coefficients composed of M columns and N rows.

As described above, the encoding process of FIG. 1 is performed as follows.

In other words, the compression method of Video-based dynamic mesh compression (V-Mesh) may provide a method of compressing dynamic mesh video data based on 2D video codecs such as High Efficiency Video Coding (HEVC) and Versatile Video Coding (VVC). In the V-Mesh compression process, the following data is received as input and compressed.

Input mesh: Includes 3D coordinates of the vertices comprising the mesh, normal information about each vertex, mapping information for mapping the surface of the mesh to a 2D plane, and connectivity between the vertices constituting the surface. The surface of the mesh may be represented by triangles or other polygons, and the connectivity information between the vertices constituting the surface is stored according to a predetermined shape. The input mesh may be stored in the OBJ file format.

Attribute map (Texture map is also used interchangeably hereafter): Contains information about the attributes (color, normals, displacements, etc.) of a mesh and stores the data in the form of a mapping of the surface of the mesh onto a 2D image. Mapping indicating which part (surface or vertex) of the mesh corresponds to each piece of data in the attribute map is based on the mapping information contained in the input mesh. Since the attribute map has data about each frame of the mesh video, it may also be referred to as an attribute map video. The attribute map in the V-Mesh compression method mainly contains the color information about the mesh and is stored in an image file format (PNG, BMP, etc.).

Material library file: Contains the material attribute information used in the mesh, specifically the information that links the input mesh to the corresponding attribute map. It is stored in the Wavefront Material Template Library (MTL) file format.

In the V-Mesh compression method, the following data and information may be generated through the compression process.

Base mesh: Represents the objects in the input mesh using the minimum vertices determined according to the user's criteria by decimating the input mesh through the pre-processing process.

Displacement: Displacement information used to represent the input mesh as similarly as possible using the base mesh, expressed in 3D coordinates.

Atlas information: Metadata needed to reconstruct a mesh using the base mesh, displacement, and attribute map information. It may be generated and utilized in sub-units (sub-mesh, patch, etc.) that constitute the mesh.

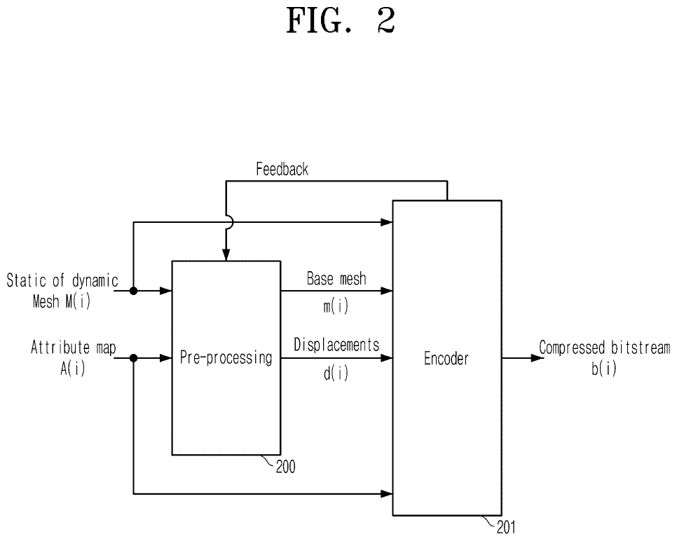

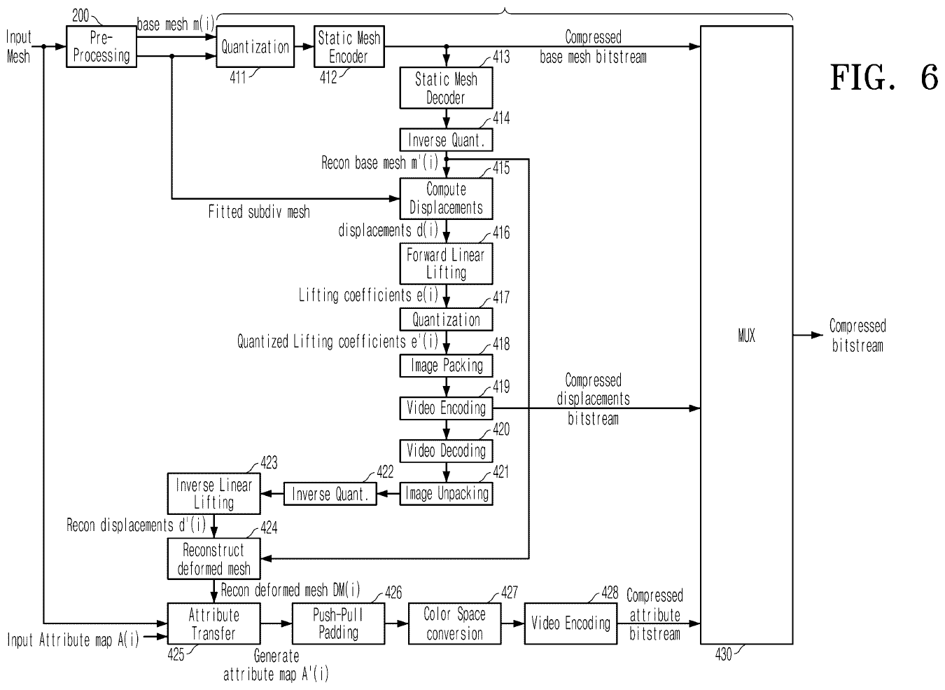

A method of encoding mesh position information (or vertex position information) is described with reference to FIGS. 2 to 7, and a method of reconstructing mesh position information to encode attribute information (attribute map) is described with reference to FIGS. 6 to 10 and the like.

FIG. 2 illustrates a V-MESH compression method according to embodiments.

FIG. 2 illustrates the encoding process of FIG. 1, wherein the encoding process may include a pre-processing process and an encoding process. The mesh video encoder 102 of FIG. 1 may include a pre-processor 200 and an encoder 201, as shown in FIG. 2. Also, the transmission apparatus of FIG. 1 may be broadly referred to as an encoder, and the mesh video encoder 102 of FIG. 1 may be referred to as an encoder. The V-Mesh compression method may include pre-processing 200 and encoding 201, as shown in FIG. 2. The pre-processor 200 of FIG. 2 may be positioned at the front end of the encoder 201 of FIG. 2. The pre-processor 200 and encoder 201 of FIG. 2 may be referred to as a single encoder.

The pre-processor 200 may receive a static of dynamic mesh (M(i)) and/or an attribute map (A(i)). The pre-processor 200 may generate a base mesh m(i) and/or displacements d(i) through pre-processing. The pre-processor 200 may receive feedback information from the encoder 201, and may generate the base mesh and/or displacements based on the feedback information.

The encoder 201 may receive the base mesh m(i), the displacements d(i), the static of dynamic mesh M(i), and/or the attribute map A(i). In the present disclosure, at least one of the base mesh m(i), the displacements d(i), the static of dynamic mesh M(i), and/or the attribute map A(i) may be referred to herein as mesh-related data. The encoder 201 may encode the mesh-related data to generate a compressed bitstream.

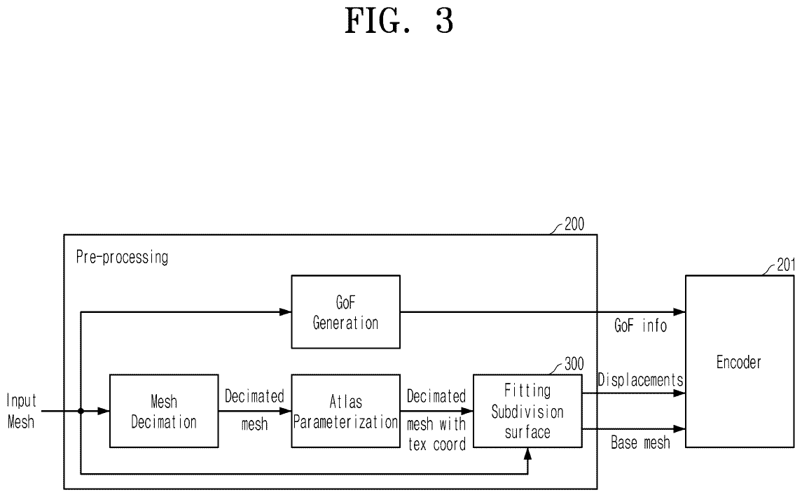

FIG. 3 illustrates pre-processing in V-MESH compression according to embodiments.

FIG. 3 illustrates the configuration and operation of the pre-processor of FIG. 2. In FIG. 3, the input mesh may include a static of dynamic mesh M(i) and/or attribute map A(i). The input mesh may also include 3D coordinates of vertices constituting the mesh, normal information about each vertex, mapping information for mapping the mesh surface to a 2D plane, and connectivity information between the vertices constituting the surface.

FIG. 3 illustrates the process of performing pre-processing on the input mesh. The pre-processing 200 may include four operations: 1) Group of Frame (GoF) generation, 2) mesh decimation, 3) UV parameterization, and 4) fitting subdivision surface (300). According to embodiments, the GoF generation may be referred to as a GoF generation process or a GoF generator, the mesh decimation may be referred to as a mesh simplification process or the mesh decimation part, the UV parameterization may be referred to as a UV parameterization process or the UV parameterization part, and the fitting subdivision surface may be referred to as a fitting subdivision surface process or a fitting subdivision surface part. The pre-processor 200 may generate displacements and/or a base mesh from the received input mesh, and deliver the same to the encoder 201. The pre-processor 200 may deliver GoF information related to the GoF generation to the encoder 201.

Hereinafter, each operation of FIG. 3 is described.

GoF generation: A process of generating a reference structure for the mesh data. When the mesh of the previous frame and the current mesh have the same number of vertices, same number of texture coordinates, same vertex connectivity information, and same texture coordinate connectivity information, the previous frame may be set as a reference frame. In other words, if only the vertex coordinate values are different between the current input mesh and the reference input mesh, the encoder 201 may perform inter frame encoding. Otherwise, it performs intra frame encoding for the frame.

Mesh decimation: A process of simplifying the input mesh to create a simplified mesh, called a base mesh. Vertices to remove may be selected from the original mesh based on user-defined criteria, and then the selected vertices and the triangles connected to the selected vertices may be removed.

In the process of performing mesh decimation, the voxelized input mesh, target triangle ratio (TTR), and minimum triangle component (CCCount) information may be delivered as input, and the decimated mesh may be obtained as output. In the process, connected triangle components that are smaller than the set minimum triangle component (CCCount) may be removed.

UV parameterization: A process of mapping a 3D curved surface into a texture domain for the decimated mesh. Parameterization may be performed using the UVAtlas tool. This process generates mapping information indicating where each vertex of the decimated mesh may be mapped to on the 2D image. The mapping information is expressed and stored as texture coordinates, and the final base mesh is generated through this process.

Fitting subdivision surface (300): A process of performing subdivision on the decimated mesh (i.e., a decimated mesh with texture coordinates). The displacements and base mesh generated by this process are output to the encoder 201. A user-defined method, such as the mid-edge method, may be applied as the subdivision method. A fitting process is performed such that the input mesh and the subdivided mesh become similar to each other. The mesh on which the fitting process is performed will be referred to herein as the fitted subdivided mesh.

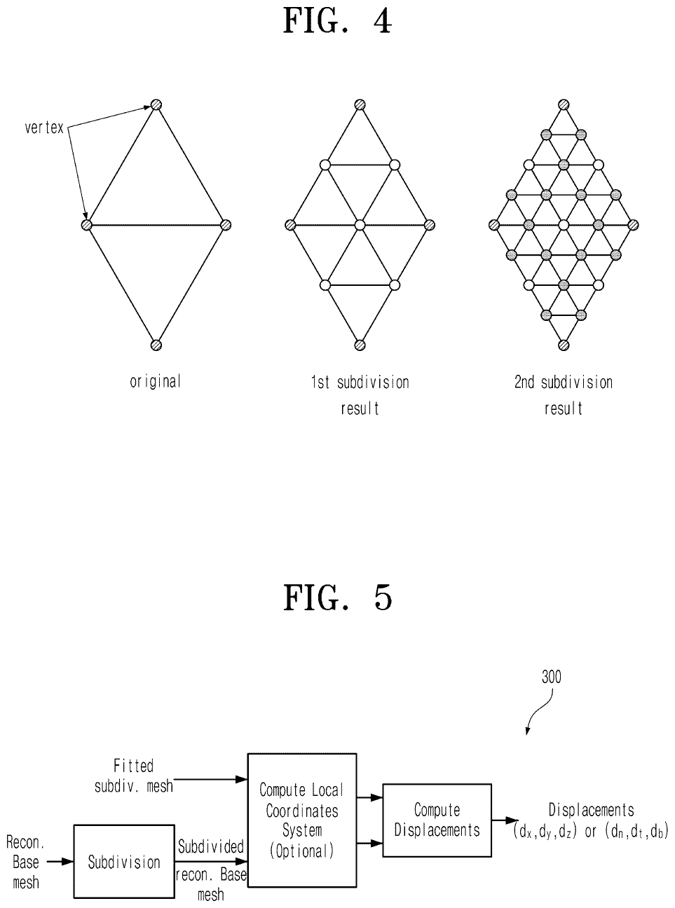

FIG. 4 illustrates a mid-edge subdivision method according to embodiments.

FIG. 4 illustrates a mid-edge subdivision method for the fitting subdivision surface described with reference to FIG. 3. Referring to FIG. 4, the original mesh containing four vertices is subdivided to create sub-meshes. The sub-meshes may be created by creating new vertices in the middle of the edges between the vertices. Then, the fitting process is performed to make the input mesh and the sub-mesh similar to each other, resulting in a fitted subdivided mesh.

Once the fitted subdivided mesh is generated, the displacements are calculated based on this result and the previously compressed and decoded base mesh (hereinafter referred to as the reconstructed base mesh). In other words, the reconstructed base mesh is subdivided in the same way as the fitting subdivision surface. The difference in position between this result and each vertex in the fitted subdivided mesh is the displacement for each vertex. Since the displacement represents a difference in position in 3D space, it is expressed as values in (x, y, z) space in the Cartesian coordinate system. Depending on a user input parameter, the coordinate values of (x, y, z) may be converted to coordinate values of (normal, tangential, bi-tangential) in a local coordinate system.

FIG. 5 illustrates a displacement generation process according to embodiments. The displacement generation process of FIG. 5 may be performed by the pre-processor 200, or may be performed by the encoder 201.

FIG. 5 illustrates in detail how displacements are calculated for the fitting subdivision surface 300, as described with reference to FIG. 4.

The encoder and/or pre-processor according to the embodiments may include 1) a subdivider, 2) a local coordinate system calculator, and 3) a displacement vector calculator. The subdivider may perform a subdivision on the reconstructed base mesh to generate a subdivided reconstructed base mesh. Here, the reconstruction of the base mesh may be performed by the pre-processor 200, or may be performed by the encoder 201. The local coordinate system calculator may receive the fitted subdivided mesh and the subdivided reconstructed base mesh, and may transform the coordinate system related to the mesh to a local coordinate system based on the received meshes. The local coordinate system calculation may be optional. The displacement calculator calculates the difference in position between the fitted subdivision mesh and the subdivided reconstructed base mesh. For example, it may generate the difference in position between the vertices in the two input meshes. The difference in position between the vertices is the displacement.

The mesh data transmission method and apparatus according to embodiments may encode the mesh data as follows. Mesh data is a term that includes point cloud data. Point cloud data (which may be referred to as a point cloud for short) according to embodiments may refer to data including vertex coordinates (also referred to as geometry information) and color information (also referred to as attribute information). In addition, a geometry image, an attribute image, an occupancy map, and auxiliary information (also referred to as patch information) generated through patch generation and packing based on vertex coordinates and color information may also be referred to as point cloud data. Therefore, point cloud data including connectivity information may be referred to as mesh data. The terms point cloud and mesh data may be used interchangeably herein.

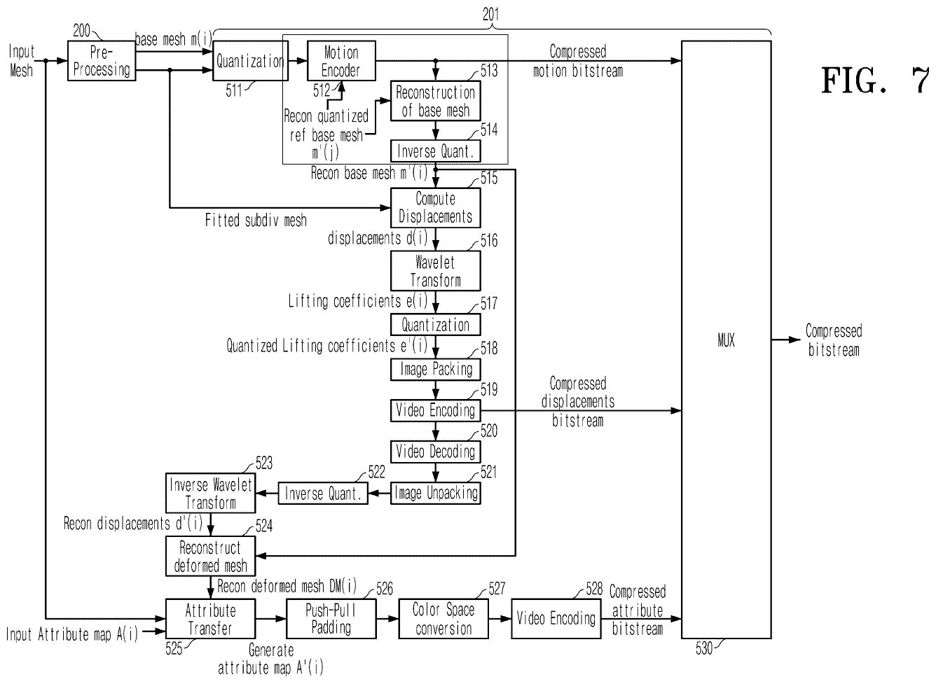

According to embodiments, the V-Mesh compression (reconstruction) method may include intra frame encoding (FIG. 6) and inter frame encoding (FIG. 7).

Based on the results of the GoF generation described above, intra frame encoding or inter frame encoding is performed. In the intra encoding, the data to be compressed may be a base mesh, displacements, an attribute map, and the like. In the inter encoding, the data to be compressed may be displacements, an attribute map, and a motion field between the reference base mesh and the current base mesh.

FIG. 6 illustrates an intra-frame encoding process in a V-MESH compression method according to embodiments. Each component for the intra-frame encoding process of FIG. 6 corresponds to hardware, software, a processor, and/or a combination thereof.

The encoding process of FIG. 6 details the encoding of the mesh video encoder 102 of FIG. 1. That is, it represents the configuration of the mesh video encoder 102 when the encoding of FIG. 1 is intra-frame encoding. The encoder of FIG. 6 may include a pre-processor 200 and/or an encoder 201. The pre-processor 200 and encoder 201 of FIG. 6 may correspond to the pre-processor 200 and encoder 201 of FIG. 3.

The pre-processor 200 may receive an input mesh and perform the pre-processing described above. A base mesh and/or a fitted subdivided mesh may be generated through the pre-processing.

The quantizer 411 of the encoder 201 may quantize the base mesh and/or the fitted subdivided mesh. The static mesh encoder 412 may encode the static mesh (i.e., the quantized base mesh) and generate a bitstream containing the encoded base mesh (i.e., a compressed base mesh bitstream). The static mesh decoder 413 may decode the encoded static mesh (i.e., the encoded base mesh). The inverse quantizer 414 may inversely quantize the quantized static mesh (i.e., base mesh) and output a reconstructed (restored) base mesh. The displacement calculator 415 may generate a displacement or displacements based on the reconstructed static mesh (i.e., base mesh) and the fitted subdivided mesh. According to embodiments, the displacement calculator 415 subdivides the reconstructed base mesh and then calculates a displacement, which is the difference in position of each vertex between the subdivided base mesh and the fitted subdivided mesh. In other words, the displacement is a displacement vector that is the difference in position between the vertices in the two meshes when the fitted subdivided mesh is similar to the original mesh. The forward linear lifter 416 may perform a lifting transform on the input displacements to generate lifting coefficients (also referred to as a transform coefficient). The quantizer 417 may quantize the lifting coefficients. The image packer 418 may pack the image based on the quantized lifting coefficients. The video encoder 419 may encode the packed image. That is, the quantized lifting coefficients are packed into a frame as a 2D image by the image packer 418, compressed by the video encoder 419, and output as a displacement bitstream (i.e., a compressed displacement bitstream).

The video decoder 420 decodes the compressed displacement bitstream. The image unpacker 421 may perform unpacking on the decoded displacement frame to output quantized lifting coefficients. The inverse quantizer 422 may inversely quantize the quantized lifting coefficients. The inverse linear lifting unit 423 applies inverse lifting to the inversely quantized lifting coefficients to generate reconstructed displacements. The mesh reconstructor 424 restores the reconstructed and deformed mesh based on the reconstructed displacements output from the inverse linear lifting unit 423 and the reconstructed base mesh (also referred to as the subdivided reconstructed base mesh) output from the inverse quantizer 414. The reconstructed and deformed mesh is referred to herein as the reconstructed deformed mesh.

The attribute transfer 425 receives an input mesh and/or an input attribute map and regenerates an attribute map based on the reconstructed deformed mesh. The attribute map refers to a texture map corresponding to attribute information among the mesh data components. In the present disclosure, the terms attribute map and texture map may be used interchangeably. The push-pull padding unit 426 may pad data to the attribute map based on a push-pull method. The color space converter 427 may convert the space of the color components of the attribute map. For example, the attribute map may be converted from an RGB color space to a YUV color space. The video encoder 428 may encode the attribute map to output a compressed attribute bitstream.

The multiplexer 430 may multiplex the compressed base mesh bitstream, the compressed displacement bitstream, and the compressed attribute bitstream to generate a compressed bitstream.

In FIG. 6, the displacement calculator 415 may be included in the pre-processor 200. Additionally, at least one of the quantizer 411, the static mesh encoder 412, the static mesh decoder 413, or the inverse quantizer 414 may be included in the pre-processor 200.

As described in FIG. 6, the intra frame encoding method includes base mesh encoding (also referred to as static mesh encoding). That is, when intra frame encoding is performed on the current input mesh frame, the base mesh generated during the pre-processing of the pre-processor 200 may be quantized by the quantizer 411 and then encoded by the static mesh encoder 412 using a static mesh compression technique. In the V-Mesh compression method, for example, the Draco technique is applied to encode the base mesh, and the vertex position information, mapping information (texture coordinates), vertex connectivity information, and the like related to the base mesh are subject to compression.

The encoder in FIG. 6 compresses the base mesh, displacements, and attributes in a frame to generate a bitstream, while the encoder in FIG. 7 compresses the motion, displacements, and attributes between the current frame and a reference frame to generate a bitstream.

FIG. 7 illustrates an inter-frame encoding process in a V-MESH compression method according to embodiments. Each component for the inter-frame encoding process of FIG. 7 corresponds to hardware, software, a processor, and/or a combination thereof.

The encoding process of FIG. 7 details the encoding of FIG. 1 in detail. That is, it represents the configuration of the encoder when the encoding of FIG. 1 is inter-frame encoding. The encoder of FIG. 7 may include a pre-processor 200 and/or an encoder 201. The pre-processor 200 and encoder 201 of FIG. 7 may correspond to the pre-processor 200 and encoder 201 of FIG. 3.

For the components of the encoding operation of FIG. 7 that correspond to the encoding operation of FIG. 6, refers to the description of FIG. 6. That is, the operations of the quantizer 511, displacement calculator 515, wavelet transformer 516, quantizer 517, image packer 518, video encoder 519, video decoder 520, image unpacker 521, inverse quantizer 522, and inverse wavelet transformer 523, mesh reconstructor 524, attribute transfer 525, push-pull padding 526, color space converter 527, video encoder 528, and multiplexer 530 in FIG. 7 are the same as or similar to the operations of the quantizer 411, static mesh encoder 412, static mesh decoder 413, and inverse quantizer 414, displacement calculator 415, forward linear lifting unit 416, quantizer 417, image packer 418, video encoder 419, video decoder 420, image unpacker 421, inverse quantizer 422, inverse linear lifting unit 423, and mesh reconstructor 424, attribute transfer 425, push-pull padding 426, color space converter 427, video encoder 428, and multiplexer 430 in FIG. 6 described above, and are therefore not described in detail in relation to FIG. 7 to avoid redundancy.

In FIG. 7, for inter-frame-based encoding, the motion encoder 512 may obtain and encode a motion vector between the reconstructed quantized reference base mesh and the quantized current base mesh, and output a compressed motion bitstream. The motion encoder 512 may be referred to as a motion vector encoder. The base mesh reconstructor 513 may reconstruct a base mesh based on the reconstructed quantized reference base mesh and the encoded motion vectors. The reconstructed base mesh is inversely quantized by the inverse quantizer 514 and output to the displacement calculator 515.

In FIG. 7, the displacement calculator 515 may be included in the pre-processor 200. Additionally, at least one of the quantizer 511, motion encoder 512, base mesh reconstructor 513, or inverse quantizer 514 may be included in the pre-processor 200.

As described with reference to FIG. 7, the inter-frame encoding method may include motion field encoding (also referred to as motion vector encoding). Inter frame encoding may be performed when the reference mesh and the current input mesh have a one-to-one correspondence of vertices, and only the position information about the vertices differs therebetween. When inter frame encoding is performed, the base mesh may not be compressed. Instead, the difference between the vertices of the reference base mesh and the current base mesh, i.e., the motion field (or motion vector) may be computed and encoded. The reference base mesh is the result of quantizing the decoded base mesh data and is determined by the reference frame index determined in the GoF generation. The motion field may be encoded as it is. Alternatively, a predicted motion field may be calculated by averaging the motion fields of the reconstructed vertices among the vertices connected to the current vertex, and a residual motion field, which is the difference between the value of the predicted motion field and the value of the motion field of the current vertex, may be encoded. The value of the residual motion field may be encoded using entropy coding. Except for the motion field encoding in the inter frame encoding, the process of encoding the displacements and attribute map is the same as the structure of the intra frame encoding method except for the base mesh encoding.

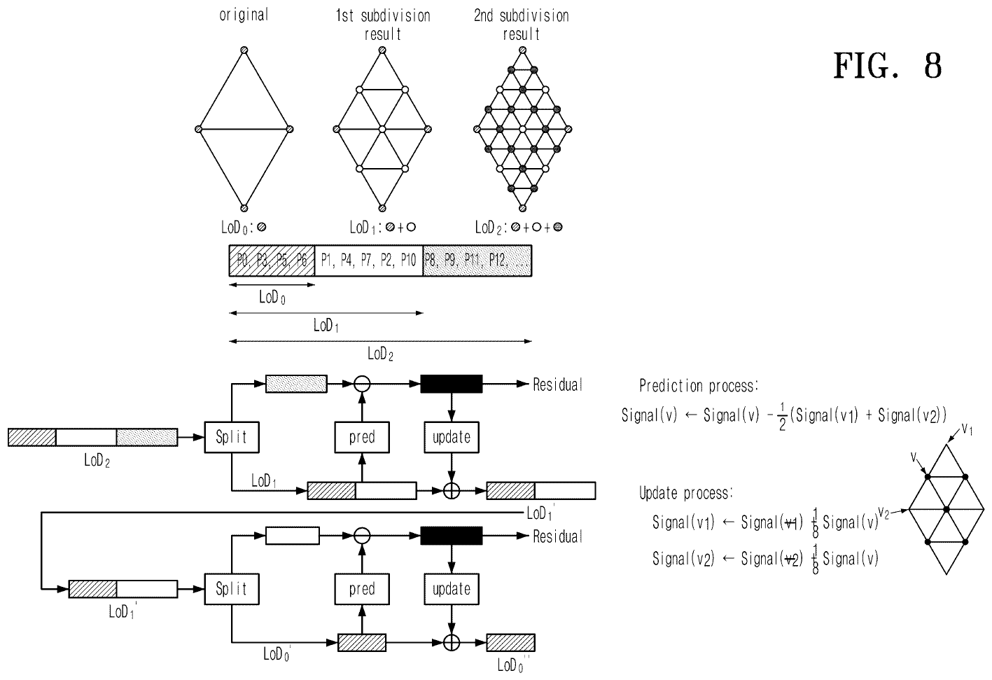

FIG. 8 illustrates a lifting transform process for displacements according to embodiments.

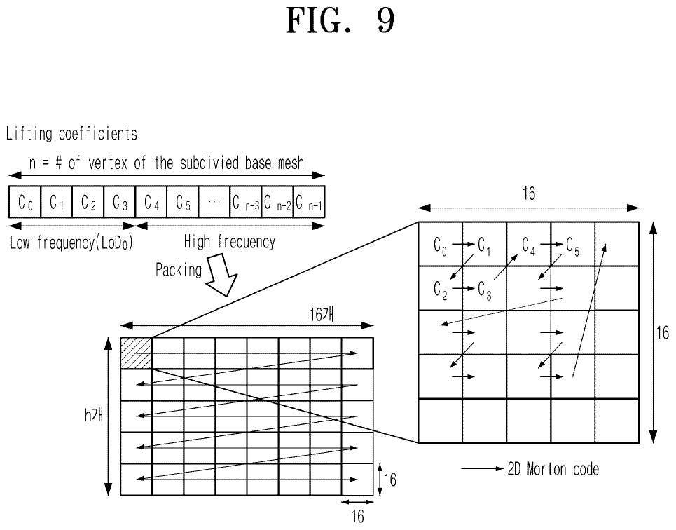

FIG. 9 illustrates a process of packing transform coefficients (also referred to as lifting coefficients) into a 2D image according to embodiments.

FIGS. 8 and 9 illustrate the process of transforming displacements and packing transform coefficients in the encoding process of FIGS. 6 and 7, respectively.

An encoding method according to the embodiments includes displacement encoding.

After base mesh encoding and/or motion field encoding, a reconstructed base mesh may be generated through reconstruction and inverse quantization, and a displacement may be calculated between a result of subdivision of the reconstructed base mesh and a fitted subdivided mesh generated through the fitting subdivision surface (see 415 in FIG. 6 or 515 in FIG. 7). A data transform process, such as a wavelet transform, may be applied to the displacement information for effective encoding (see 416 in FIG. 6, or 516 in FIG. 7).

FIG. 8 illustrates the process of transforming displacement information by the forward linear lifting unit 416 of FIG. 6 or the wavelet transformer 516 of FIG. 7 using the lifting transform. For example, a linear wavelet-based lifting transform may be performed. The transform coefficients generated through the transform process are quantized by the quantizer 417 (or 517) and then packed into a 2D image by the image packer 418 (or 518), as shown in FIG. 9. The transform coefficients may be organized into blocks, one block for every 256 (=16×16) units. Each block may be packed in a z-scan order. The number of rows in a block is fixed to 16, but the number of columns in the block may be determined by the number of vertices in the subdivided base mesh. Within a block, the transform coefficients may be sorted with the Morton code and packed. For the packed images, a displacement video may be generated per GoF. The displacement video may be encoded by the video encoder 419 (or 519) using a conventional video compression codec.

Referring to FIG. 8, the base mesh (original) may include vertices and edges for LoD0. A first subdivision mesh generated by splitting (or subdividing) the base mesh includes vertices generated by further splitting (or subdividing) the edges of the base mesh. The first subdivision mesh contains vertices for LoD0 and vertices for LoD1. LoD1 includes subdivided vertices and vertices from the base mesh (LoD0). The first subdivision mesh may be split (or subdivided) to generate a second subdivision mesh. The second subdivision mesh contains LoD2. LoD2 includes a base mesh vertex (LoD0), LoD1 containing vertices further split (or subdivided) from LoD0, and LoD2 containing vertices further split (or subdivided) from LoD1. LoD is a level of detail that indicates how detailed the mesh data content is. As the index of the level increases, the distance between vertices is shortened, and the level of detail rises. In other words, as the value of LoD decreases, the detail of the mesh data content is degraded. As the value of LoD increases, the detail of the mesh data content is enhanced. LoD N contains the vertices contained in LoD N−1. In the case where the mesh (or vertex) is further split through subdivision, the mesh may be encoded based on a prediction and/or updating method, taking into account the previous vertices v1 and v2, and the subdivided vertex v. Instead of encoding the information for the current LoD N as it is, a residual with respect to previous LoD N−1 may be generated. Thus, the mesh may be encoded using the residual to reduce the size of the bitstream. The prediction process refers to the operation of predicting the current vertex v from the previous vertices v1 and v2. Since neighboring subdivision meshes have similar data, this property may be exploited for efficient encoding. The current vertex position information is predicted from the residual for the previous vertex position information, and the previous vertex position information is updated through the residual. In the present disclosure, vertex and point may be used interchangeably. The LoDs may be defined in the subdivision of the base mesh. According to embodiments, the subdivision of the base mesh may be performed by the pre-processor 200 or may be performed by a separate component/module.

Referring to FIG. 9, a vertex has a transform coefficient (also referred to as a lifting

coefficient) generated through lifting transform. The transform coefficient of the vertex related to the lifting transform may be packed into an image by the image packer 418 (or 518) and then encoded by the video encoder 419 (or 519).

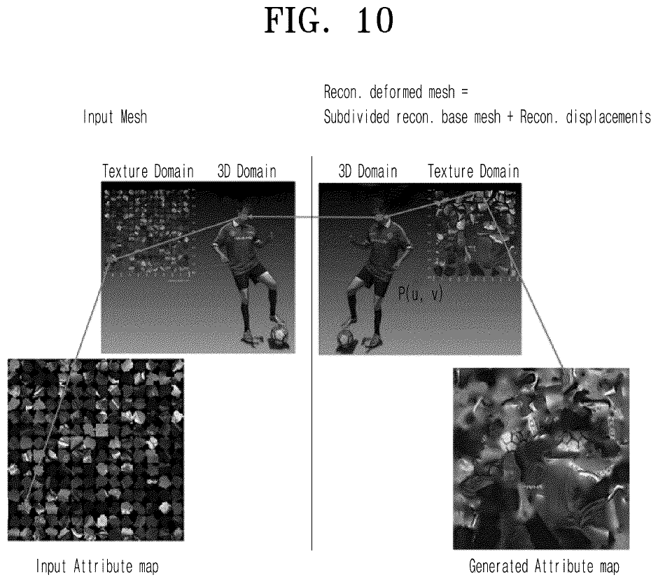

FIG. 10 illustrates an attribute transfer process in a V-MESH compression method according to embodiments.

According to embodiments, FIG. 10 illustrates a detailed operation of the attribute transfer 425 (or 525) in the encoding of FIGS. 6, 7, etc.

The encoding according to the embodiments includes attribute map encoding. According to embodiments, the attribute map encoding may be performed by the video encoder 428 of FIG. 6 or the video encoder 528 of FIG. 7.

According to embodiments, in the present disclosure, the encoder compresses information about the input mesh through base mesh encoding (i.e., intra-encoding), motion field encoding (i.e., inter-encoding), and displacement encoding. The input mesh compressed in the encoding process is reconstructed through base mesh decoding (intra frame), motion field decoding (inter frame), and displacement video decoding, and the reconstructed deformed mesh (hereinafter referred to as Recon. deformed mesh), which is the result of the reconstruction, is used to compress the input attribute map, as shown in FIGS. 6 and 7. The Recon. deformed mesh has position information about vertices, texture coordinates, and corresponding connectivity information, but does not have color information corresponding to the texture coordinates.

Therefore, as shown in FIG. 10, in the V-Mesh compression method, a new attribute map having color information corresponding to the texture coordinates of the recon. deformed mesh is re-generated through the attribute transfer process of the attribute transfer 425 (or 525).

According to embodiments, the attribute transfer 425 (or 525) first checks, for every point P(u, v) in the 2D texture domain, whether the corresponding vertex is within a texture triangle of the Recon. deformed mesh. When the corresponding vertex is in the texture triangle T, the attribute transfer calculates the barycentric coordinates (α, β, γ) of P(u, v) according to the triangle T. Then, it calculates the 3D coordinates M(x, y, z) of P(u, v) based on the 3D vertex positions of the triangle T and (α, β, γ). The vertex coordinates M′(x′, y′, z′) that corresponds to the closest position to the calculated M(x, y, z) and a triangle T′ containing this vertex are searched for in the input mesh domain. Then, the barycentric coordinates (α′, β′, γ′) of M′(x′, y′, z′) in the triangle T′ are calculated. The texture coordinates (u′, v′) are calculated based on the texture coordinates corresponding to the three vertices of triangle T′ and (α′, β′, γ′), and the color information corresponding to the coordinates are searched for in the input attribute map. The color information found in this way is then assigned to the (u, v) pixel position in the new input attribute map. If P(u, v) does not belong to any triangle, the pixel at the position in the new input attribute map be filled with a color value using a padding algorithm, such as the push-pull algorithm of the push-pull padding 426 (or 526).

The new attribute map generated by the attribute transfer 425 (or 525) is bundled into GoFs to construct an attribute map video, which is compressed using a video codec of the video encoder 428 (or 528).

A reference relationship between the input mesh, the input attribute map, the reconstructed deformed mesh, and the reconstructed attribute map is shown may be seen from FIG. 10.

The decoding process of FIG. 1 may perform the reverse of the encoding process of FIG. 1. Specifically, the decoding process is performed as disclosed below.

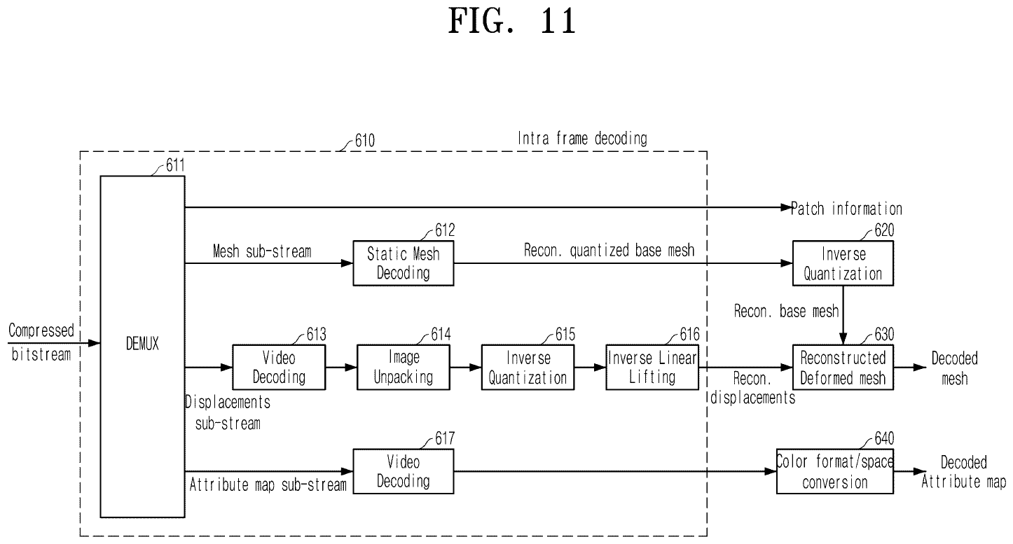

FIG. 11 shows the intra-frame decoding (or intra decoding) process of the V-Mesh technology according to embodiments.

FIG. 11 illustrates the configuration and operation of the mesh video decoder 113 of the reception apparatus of FIG. 1. Additionally, FIG. 11 illustrates that the mesh data may be reconstructed by performing a reverse process to the intra-frame encoding process of FIG. 6. Each component for the intra-frame decoding process of FIG. 11 corresponds to hardware, software, and/or a combination thereof.

First, the bitstream (i.e., compressed bitstream) received and input to the demultiplexer 611 of the intra-frame decoder 610 may be separated into a mesh sub-stream, a displacement sub-stream, an attribute map sub-stream, and a sub-stream containing patch information about the mesh, such as V-PCC/V3C. The term V-PCC (Video-based Point Cloud Compression) used in the present disclosure may have the same meaning as V3C (Visual Volumetric Video-based Coding). The two terms may be used interchangeably. Accordingly, in the present disclosure, the term V-PCC may be interpreted as V3C.

According to embodiments, the mesh sub-stream may be input to and decoded by a static mesh decoder 612, the displacement sub-stream may be input to and decoded by the video decoder 613, and the attribute map sub-stream may be input to and decoded by the video decoder 617.

According to embodiments, the mesh sub-stream may be decoded through the decoder 612 of a static mesh codec used in the encoding such as, for example, Google Draco, to reconstruct connectivity information, vertex geometry information, vertex texture coordinates, and the like related to the result of the decoding, a recon. quantized base mesh, e.g., reconstructed base mesh.

According to embodiments, the displacement sub-stream may be decoded into a displacement video through the decoder 613 of the video compression codec used in the encoding. Then, image unpacking is performed by the image unpacker 614, inverse quantization is performed by the inverse quantizer 615, and inverse transform is performed by the inverse linear lifting unit 616 to reconstruct the displacement information about each vertex (i.e., Recon. displacements).

According to embodiments, the base mesh reconstructed by the static mesh decoder 612 is inversely quantized by the inverse quantizer 620 and output to the mesh reconstructor 630. The mesh reconstructor 630 reconstructs a reconstructed deformed mesh (i.e., a decoded mesh) based on the reconstructed displacements output from the inverse linear lifting unit 616 and the reconstructed base mesh output from the inverse quantizer 620. In other words, the inversely quantized reconstructed base mesh is combined with the reconstructed displacement information to generate a final decoded mesh. In the present disclosure, the final decoded mesh is referred to as a reconstructed deformed mesh.

According to embodiments, the attribute map sub-stream is decoded by the decoder 617 corresponding to the video compression codec used in the encoding, and then a final attribute map (i.e., a decoded attribute map) is reconstructed by the color transformer 640 through color format transform, color space conversion, and the like.

According to embodiments, the reconstructed decoded mesh and decoded attribute map may be utilized at the receiving side as final mesh data that may be utilized by a user.

Referring to FIG. 11, the received compressed bitstream includes patch information, a mesh sub-stream, a displacement sub-stream, and an attribute map sub-stream. The term sub-stream is interpreted as referring to a partial bitstream included in the bitstream. The bitstream contains patch information (data), mesh information (data), displacement information (data), and attribute map information (data).

As described above, the decoder of FIG. 11 performs intra-frame decoding as follows. The static mesh decoder 612 decodes the mesh sub-stream to generate a reconstructed quantized base mesh, and the inverse quantizer 620 applies the quantization parameters of the quantizer in reverse to generate a reconstructed base mesh. The video decoder 613 decodes the displacement sub-stream, the image unpacker 614 unpacks the image of the decoded displacement video, and the inverse quantizer 615 inversely quantizes the quantized image. The inverse linear lifting unit 616 applies a lifting transform in the reverse process of the encoder to generate a reconstructed displacement. The mesh reconstructor 630 generates a reconstructed deformed mesh based on the reconstructed base mesh and the reconstructed displacement. The video decoder 617 decodes the attribute map sub-stream, and the color transformer 640 transforms the color format and/or space of the decoded attribute map to generate a decoded attribute map.

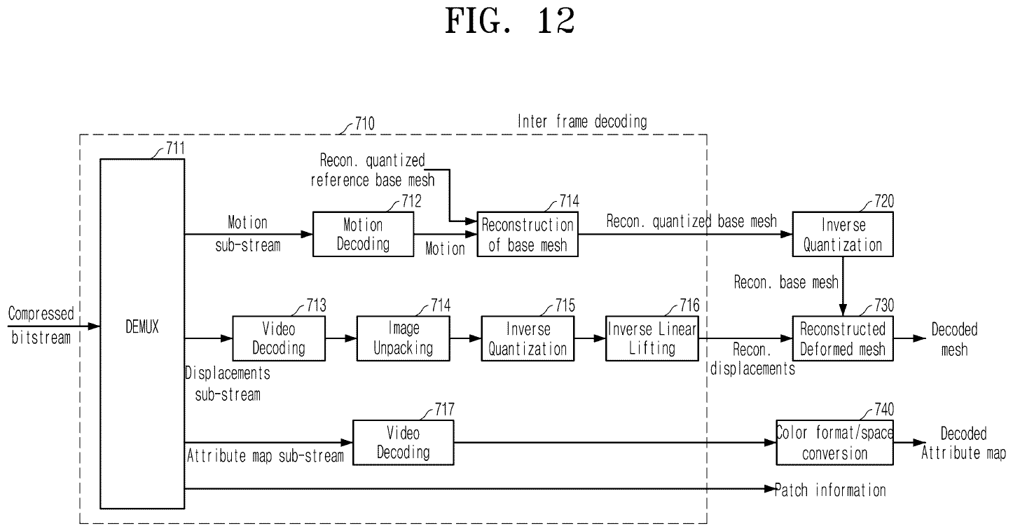

FIG. 12 illustrates an inter-frame decoding (or inter-decoding) process of V-Mesh technology.

FIG. 12 illustrates the configuration and operation of the mesh video decoder 113 of the reception apparatus of FIG. 1. In FIG. 12, mesh data may be reconstructed by performing a reverse process to the inter-frame encoding process of FIG. 7. Each component for the intra-frame decoding process of FIG. 12 corresponds to hardware, software, and/or a combination thereof.

First, the bitstream received and input to the demultiplexer 711 of the intra-frame decoder 710 may be separated into a motion sub-stream (also referred to as a motion vector sub-stream), a displacement sub-stream, an attribute map sub-stream, and a sub-stream containing patch information about the mesh, such as V3C/V-PCC.

According to embodiments, the motion sub-stream may be input to and decoded by the motion decoder 712, the displacement sub-stream may be input to and decoded by the video decoder 713, and the attribute map sub-stream may be input to and decoded by the video decoder 717.

According to embodiments, the motion sub-stream is decoded by the motion decoder 712 through entropy decoding and inverse prediction to reconstruct motion information (also referred to as motion vector information). The base mesh reconstructor 718 combines the reconstructed motion information with a pre-reconstructed and stored reference base mesh to generate a reconstructed quantized base mesh for the current frame. The inverse quantizer 720 applies inverse quantization to the reconstructed quantized base mesh to generate a reconstructed base mesh. The video decoder 713 decodes the displacement sub-stream, the image unpacker 714 unpacks the image of the decoded displacement video, and the inverse quantizer 715 inversely quantizes the quantized image. The inverse linear lifting unit 716 applies a lifting transform in the reverse process of the encoder to generate a reconstructed displacement. The mesh reconstructor 730 generates a reconstructed deformed mesh, i.e., a final decoded mesh, based on the reconstructed base mesh and the reconstructed displacement.

According to embodiments, the video decoder 717 decodes the attribute map sub-stream in the same way as the intra-decoding, and the color transformer 740 transforms the color format and/or space of the decoded attribute map to generate a decoded attribute map. The decoded mesh and decoded attribute map may be utilized at the receiving side as the final mesh data that may be utilized by the user.

Referring to FIG. 12, the bitstream contains motion information (also referred to as motion vectors), displacements, and an attribute map. The process of FIG. 12 further includes decoding the inter-frame motion information because inter-frame decoding is performed. A reconstructed base mesh is generated by decoding the motion information and generating a reconstructed quantized base mesh for the motion information based on the reference base mesh. For the operations in FIG. 12 that are the same as those in FIG. 11, refer to the description of FIG. 11.

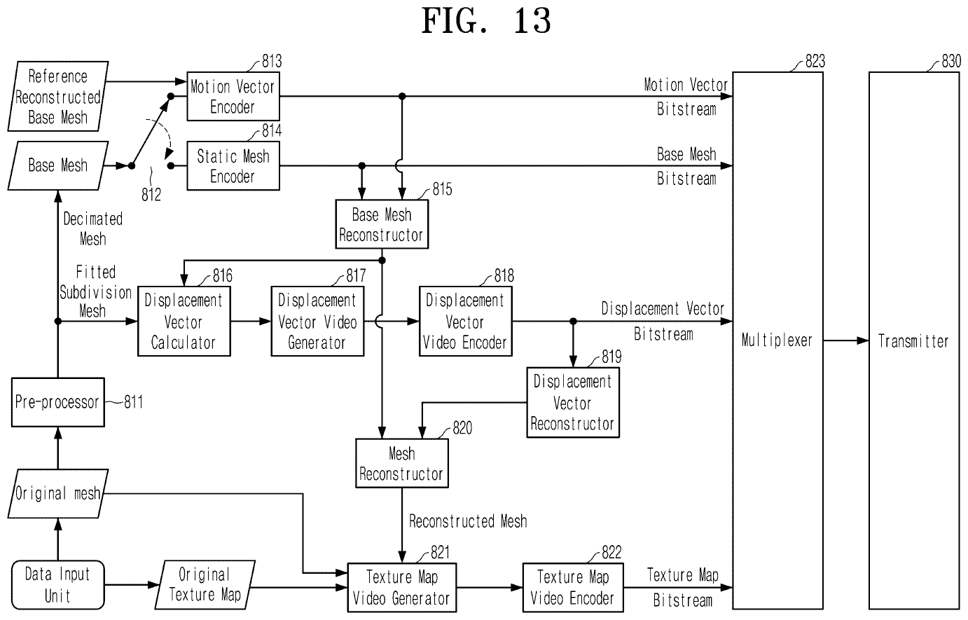

FIG. 13 illustrates a mesh data transmission apparatus according to embodiments.

FIG. 13 corresponds to the transmission apparatus 100 or mesh video encoder 102 of FIG. 1, the encoder (pre-processor and encoder) of FIG. 2, 6, or 7, and/or the corresponding transmission encoding device. Each component of FIG. 13 corresponds to hardware, software, a processor, and/or a combination thereof.

The process of operations at the transmitting end for compressing and transmitting dynamic mesh data using a V-Mesh compression technique may be configured as shown in FIG. 13. The transmission apparatus of FIG. 13 may perform intra-frame encoding (also referred to as intra-encoding or intra-picture encoding) and/or inter-frame encoding (also referred to as inter-encoding or inter-picture encoding).

The pre-processor 811 receives the original mesh and generates a decimated mesh (or base mesh) and a fitted subdivided (or subdivision) mesh. The decimation may be performed based on a target number of vertices or a target number of polygons constituting the mesh. Parameterization may be performed on the decimated mesh to generate texture coordinates and texture connectivity information per vertex. For example, the parameterization is a process of mapping a 3D curved surface into a texture domain for the decimated mesh. When the parameterization is performed using the UVAtlas tool, mapping information indicating where each vertex of the decimated mesh may be mapped to on the 2D image is generated. The mapping information is expressed and stored as texture coordinates, and the final base mesh is generated through this process. The mesh information may be quantized from a floating-point form to a fixed-point form. The result is the base mesh, which may be output to a motion vector encoder 813 or a static mesh encoder 814 through a switching unit 812. The pre-processor 811 may perform a mesh subdivision on the base mesh to generate additional vertices. Depending on the subdivision method, vertex connectivity information including the additional vertices, texture coordinates, and connectivity information about the texture coordinates may be generated. The pre-processor 811 may generate a fitted subdivided mesh by adjusting vertex positions such that the subdivided mesh becomes similar to the original mesh.

According to embodiments, when inter-frame encoding (inter-encoding) is performed on the mesh frame, the base mesh is output to the motion vector encoder 813 through the switching unit 812. When intra-frame encoding (intra-encoding) is performed on the mesh frame, the base mesh is output to the static mesh encoder 814 through the switching unit 812. The motion vector encoder 813 may be referred to as a motion encoder.

For example, when intra-encoding (intra-frame encoding) is performed on the mesh frame, the base mesh may be compressed through the static mesh encoder 814. In this case, the connectivity information, vertex geometry information, vertex texture information, normal information, and the like related to the base mesh may be encoded. The base mesh bitstream generated through the encoding is transmitted to the multiplexer 823.

As another example, when inter-encoding (inter-frame encoding) is performed on the mesh frame, the motion vector encoder 813 may receive as input a base mesh and a reference reconstructed base mesh (or a reconstructed quantized reference base mesh), compute a motion vector between the two meshes, and encode the value thereof. Further, the motion vector encoder 813 may perform connectivity information-based prediction using the previously encoded/decoded motion vector as a predictor, and encode a residual motion vector, which is obtained by subtracting the predicted motion vector from the current motion vector. The motion vector bitstream generated by the encoding is transmitted to the multiplexer 823.

The base mesh reconstructor 815 may receive the base mesh encoded by the static mesh encoder 814 or the motion vector encoded by the motion vector encoder 813, and generate a reconstructed base mesh. For example, the base mesh reconstructor 815 may perform static mesh decoding on the base mesh encoded by the static mesh encoder 814 to reconstruct the base mesh. In this case, quantization may be applied before the static mesh decoding, and inverse quantization may be applied after the static mesh decoding. In another example, the base mesh reconstructor 815 may reconstruct the base mesh based on the reconstructed quantized reference base mesh and the motion vector encoded by the motion vector encoder 813. The reconstructed base mesh is output to the displacement calculator (or displacement vector calculator) 816 and the mesh reconstructor 820.

The displacement calculator 816 may perform mesh subdivision on the reconstructed base mesh. The displacement calculator 816 may calculate a displacement vector, which is the value of the difference in vertex positions between the subdivided reconstructed base mesh and the fitted subdivision (or subdivided) mesh generated by the pre-processor 811. In this case, displacement vectors as many as vertices in the subdivided mesh may be calculated. The displacement calculator 816 may transform the displacement vectors calculated in the 3D Cartesian coordinate system to a local coordinate system based on the normal vector of each vertex.

The displacement vector video generator 817 may include a linear lifting part, a quantizer, and an image packer. That is, in displacement vector video generator 817, the linear lifting unit may transform the displacement vectors for effective encoding. According to embodiments, the transform may be lifting transform, wavelet transform, or the like. In addition, the quantizer may perform quantization on the transformed displacement vector values, i.e., the transform coefficients. In this case, different quantization parameters may be applied to the axes of the transform coefficients, respectively. The quantization parameters may be derived by an agreement between the encoder/decoder. After transform and quantization, the displacement vector information may be packed into a 2D image by the image packer. The displacement vector video generator 817 may generate a displacement vector video by grouping the packed 2D images for each frame. A displacement vector video may be generated for each group of frames (GoF) of the input mesh.

The displacement vector video encoder 818 may encode the generated displacement vector video using a video compression codec. The generated displacement vector video bitstream is transmitted to the multiplexer 823.

The displacement vector reconstructor 819 may include a video decoder, an image unpacker, an inverse quantizer, and an inverse linear lifting part. That is, in the displacement vector reconstructor 819, the encoded displacement vector is decoded by the video decoder, image unpacking is performed by the image unpacker, inverse quantization is performed by the inverse quantizer, and inverse transform is performed by the inverse linear lifting unit to reconstruct displacement vectors. The reconstructed displacement vectors are output to the mesh reconstructor 820. The mesh reconstructor 820 reconstructs a deformed mesh based on the base mesh reconstructed by the base mesh reconstructor 815 and the displacement vectors reconstructed by the displacement vector reconstructor 819. The reconstructed mesh (also referred to as the reconstructed deformed mesh) has reconstructed vertices, inter-vertex connectivity information, texture coordinates, and inter-texture coordinate connectivity information.

The texture map video generator 821 may re-generate a texture map based on the texture map (or attribute map) of the original mesh and the reconstructed deformed mesh output from the mesh reconstructor 820. According to embodiments, the texture map video generator 821 may assign the vertex-by-vertex color information in the texture map of the original mesh to the texture coordinates of the reconstructed deformed mesh. According to embodiments, the texture map video generator 821 may generate a texture map video by grouping the frame-level re-generated texture maps into GoFs.

The generated texture map video may be encoded by the texture map video encoder 822 using a video compression codec. A texture map video bitstream generated through the encoding is transmitted to the multiplexer 823.

The multiplexer 823 multiplexes the motion vector bitstream (in the case of, for example, inter-encoding), the base mesh bitstream (in the case of, for example, intra-encoding), the displacement vector bitstream, and the texture map bitstream into a single bitstream. The single bitstream may be transmitted to the receiving side through the transmitter 824. Alternatively, for the motion vector bitstream, the base mesh bitstream, the displacement vector bitstream, and the texture map bitstream, a file with one or more track data may be generated or the bitstreams may be encapsulated into segments and transmitted to the receiving side through the transmitter 824.

Referring to FIG. 13, the transmitter (encoder) may encode the mesh in an intra-frame or inter-frame manner. According to intra-encoding, the transmission apparatus may generate a base mesh, displacement vectors (or displacements), and a texture map (or attribute map). According to inter-encoding, the transmission apparatus may generate a motion vector (or motion), displacement vectors (or displacements), and a texture map (or attribute map). The texture map acquired from the data input unit is generated and encoded based on the reconstructed mesh. The displacements are generated and encoded based on the differences in vertex positions between the base mesh and the segmented (or subdivided) mesh. More specifically, the displacement is a difference in position between the fitted subdivided mesh and the subdivided reconstructed base mesh, i.e., the difference in vertex position between the two meshes. The base mesh is generated by decimating the original mesh through pre-processing and encoding the decimated mesh. For the motion, a motion vector is generated for the mesh in the current frame based on the reference base mesh in the previous frame.

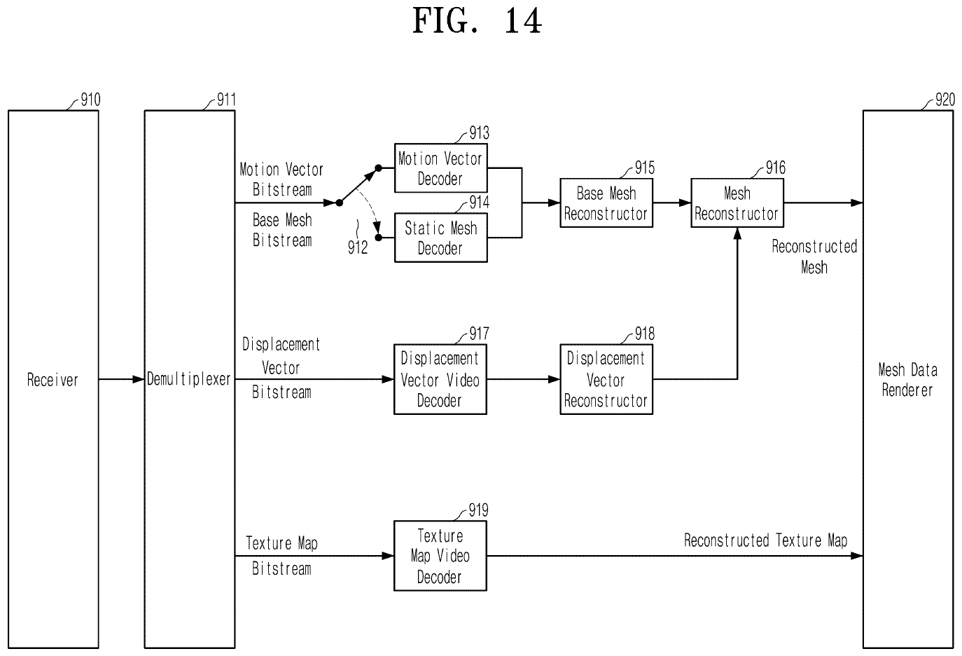

FIG. 14 illustrates a mesh data reception apparatus according to embodiments.

FIG. 14 corresponds to the reception apparatus 110 or mesh video decoder 113 of FIG. 1, the decoder of FIG. 11 or 12, and/or a corresponding receiving decoding device. Each component of FIG. 14 corresponds to hardware, software, a processor, and/or a combination thereof. The reception (decoding) operation of FIG. 14 may follow a reverse process to the corresponding process of the transmission (encoding) operation of FIG. 13.

The bitstream of mesh data received by the receiver 910 is subjected to file/segment decapsulation and then demultiplexed by the demultiplexer 911 into a compressed motion vector bitstream (e.g., inter-decoding) or base mesh bitstream (e.g., intra-decoding), a displacement vector bitstream, and a texture map bitstream. For example, when the current mesh is inter-frame encoded (i.e., inter-encoded), the motion vector bitstream is received, demultiplexed, and then output to the motion vector decoder 913 through the switching unit 912. In another example, when the current mesh is intra-frame encoded (i.e., intra-encoded), the base mesh bitstream is received, demultiplexed, and output to the static mesh decoder 914 through the switching unit 912. Here, the motion vector decoder 913 may be referred to as a motion decoder.

According to embodiments, in the case where inter-frame encoding is applied to the current mesh based on the frame header information, the motion vector decoder 913 may decode the motion vector bitstream. According to embodiments, the motion vector decoder 913 may use the previously decoded motion vector as a predictor and add the same to the residual motion vector decoded from the bitstream to reconstruct the final motion vector.

According to embodiments, in the case where intra-frame encoding is applied to the current mesh based on the frame header information, the static mesh decoder 914 may decode the base mesh bitstream to reconstruct connectivity information, vertex geometry information, texture coordinates, normal information, and the like related to the base mesh.

According to embodiments, the base mesh reconstructor 915 may reconstruct the current base mesh based on the decoded motion vectors or the decoded base mesh. For example, in the case where inter-frame encoding is applied to the current mesh, the base mesh reconstructor 915 may add the decoded motion vectors to the reference base mesh and perform inverse quantization to generate a reconstructed base mesh. In another example, in the case where intra-frame encoding is applied to the current mesh, the base mesh reconstructor 915 may perform inverse quantization on the base mesh decoded by the static mesh decoder 914 to generate a reconstructed base mesh.

According to embodiments, the displacement vector video decoder 917 may decode the displacement vector bitstream as a video bitstream using a video codec.

According to embodiments, the displacement vector reconstructor 918 extracts displacement vector transform coefficients from the decoded displacement vector video, and applies inverse quantization and inverse transform to the extracted displacement vector transform coefficients to reconstruct displacement vectors. To this end, the displacement vector reconstructor 918 may include an image unpacker, an inverse quantizer, and an inverse linear lifting part. If the reconstructed displacement vectors are values in a local coordinate system, inverse transform to the Cartesian coordinate system may be performed.

The mesh reconstructor 916 may subdivide the reconstructed base mesh to generate additional vertices. Through the subdivision, vertex connectivity information including the additional vertices, texture coordinates, and connectivity information about the texture coordinates may be generated. In this case, the mesh reconstructor 916 may combine the subdivided reconstructed base mesh with the reconstructed displacement vectors to generate a final reconstructed mesh (also referred to as a reconstructed deformed mesh).

According to embodiments, the texture map video decoder 919 may decode the texture map bitstream as a video bitstream using a video codec to reconstruct a texture map. The reconstructed texture map has color information about each vertex in the reconstructed mesh, and the texture coordinates of each vertex may be used to obtain the color value of the vertex from the texture map.

According to embodiments, the mesh reconstructed from the mesh reconstructor 916 and the texture map reconstructed from the texture map video decoder 919 are presented to the user through a rendering process in the mesh data renderer 920.

Referring to FIG. 14, the reception apparatus (decoder) may decode the mesh in an intra-frame or inter-frame manner. According to intra-decoding, the reception apparatus may receive a base mesh, displacement vectors (or displacements), and a texture map (or attribute map), and render mesh data based on the reconstructed mesh and reconstructed texture map. According to inter-decoding, the reception apparatus may receive a motion vector (or motion), the displacement vectors (or displacements), a texture map (or attribute map), and render mesh data based on the reconstructed mesh and the reconstructed texture map.

A mesh data transmission device and method according to embodiments may pre-process mesh data, encode the pre-processed mesh data, and transmit a bitstream containing the encoded mesh data. A point mesh data reception device and method according to embodiments may receive a bitstream containing mesh data and decode the mesh data. The mesh data transmission/reception method/device according to embodiments may be referred to as a method/device according to embodiments. The mesh data transmission/reception method/device may also be referred to as a 3D data transmission/reception method/device or point cloud data transmission/reception method/device.

As described above, the transmission device for V-Mesh regenerates the texture map of a reconstructed mesh from the texture map of the input original mesh during the encoding process, and then processes the regenerated texture map images into a video stream for compression. Furthermore, the encoding process in the transmission device supports intra (intra-frame prediction) mode and inter (inter-frame prediction) mode.

According to embodiments, the transmission device may perform inter-frame prediction on mesh data on a vertex-by-vertex basis. In particular, when encoding the geometry information related to 3D dynamic mesh data using inter-frame prediction, a per-vertex motion vector may be calculated, and the per-vertex motion vector or a difference motion vector may be transmitted. In this case, since the per-vertex (difference) motion vector needs to be transmitted, the amount of data to be transmitted/parsed is large.

To address this issue, the present disclosure proposes a method of encoding and decoding motion vectors or difference motion vectors on a per-subgroup basis, which is intended to improve the inter (inter-frame prediction) mode technique of V-Mesh.

According to embodiments, when encoding/decoding the geometry information related to 3D dynamic mesh data using inter-frame prediction, motion vectors of similar vertices may be partitioned into subgroups, and may be calculated on a per-subgroup basis. Then, the per-subgroup motion vector or difference motion vector may be transmitted. In particular, when the motion vectors of the vertices within a subgroup are similar, only the (difference) motion vector per subgroup may be transmitted, and the transmission of the (difference) motion vector per vertex may be skipped. Thereby, the number of bits to be transmitted/parsed may be reduced. Additionally, the present disclosure may allow for determining the resolution of motion vectors on a per-subgroup basis.

In the present disclosure, geometry information (or geometry or geometry data) refers to one of the elements that constitute a mesh, including vertices (or points), edges, and polygons. Here, a vertex defines a position in 3D space, an edge represents connectivity information between vertices, and a polygon, formed by a combination of edges and vertices, defines the surface of the mesh. In other words, each vertex that constitutes the mesh represents a position in 3D space, expressed by, for example, X, Y, and Z coordinates. The polygon may be a triangle or a rectangle. Therefore, geometry forms the skeleton of a 3D model, defining the shape of the model, which is visually represented when rendered.

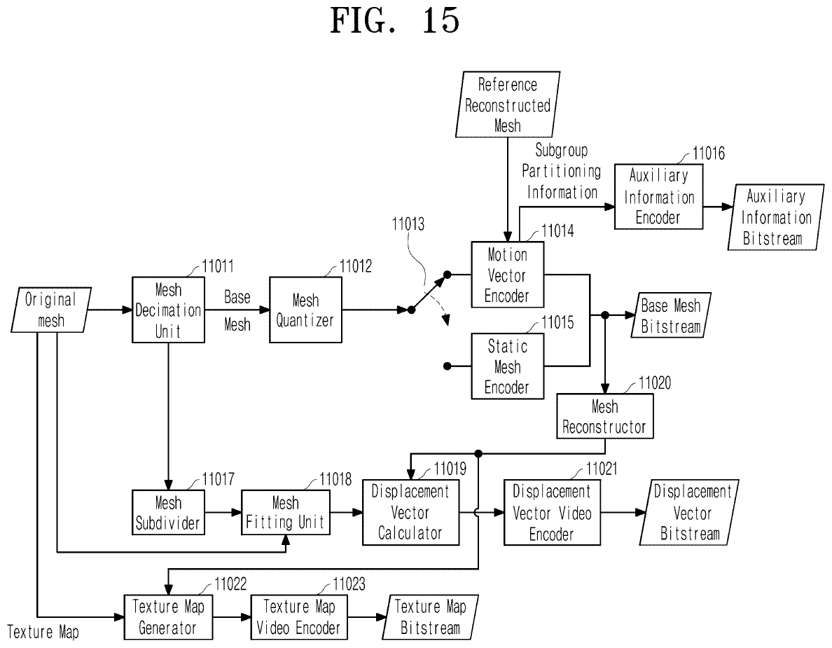

FIG. 15 illustrates a mesh data transmission device according to embodiments. The transmission device in FIG. 15 may be referred to as an encoder.

FIG. 15 corresponds to the transmission device 100 or mesh video encoder 102 of FIG. 1, the encoder (preprocessor and encoder) of FIG. 2, 6, or 7, the transmission device of FIG. 13, and/or the corresponding transmission encoding device. Each component in FIG. 15 corresponds to hardware, software, a processor, and/or a combination thereof. In FIG. 15, the execution order of the blocks may be changed, some blocks may be omitted, and new blocks may be added.

In the transmission device of FIG. 15, the dynamic mesh encoder simplifies the dynamic mesh to create a base mesh, and then uses an incremental encoding method to gradually form the complex mesh from the base mesh to encode the mesh.

That is, the operation process at the transmitting side for compression and transmission of dynamic mesh data using the V-Mesh compression technique may be performed as illustrated in FIG. 15. The transmission device in FIG. 15 may support both an intra-frame encoding (also referred to as intra encoding) process and/or an inter-frame encoding (also referred to as inter encoding) process.

In FIG. 15, the mesh decimation unit 11011 simplifies the input original mesh to generate a base mesh. The mesh simplification may be performed based on the number of target vertices or the number of target polygons constituting the mesh. For example, methods such as decimation may be used to simplify the original mesh. Specifically, the decimation may be a process of selecting vertices to be removed from the original mesh based on a certain reference point, and then removing the selected vertices and the triangles connected to the selected vertices. The base mesh generated by the mesh decimation unit 11011 is input into the mesh quantizer 11012 so as to be quantized. According to embodiments, the mesh quantizer 11012 may quantize mesh information in floating-point form to fixed-point form.

Additionally, the base mesh generated by the mesh decimation unit 11011 is input into the mesh subdivider 11017 and subdivided. That is, the mesh subdivider 11017 performs mesh subdivision on the base mesh to generate additional vertices. Depending on the subdivision method, vertex connectivity information, texture coordinates, and texture coordinate connectivity information including the added vertices may be generated. The mesh fitting unit 11018 performs fitting by adjusting the vertex positions such that the subdivided mesh from the mesh subdivider 11017 becomes similar to the original mesh, thereby generating a fitted subdivided mesh.

In the present disclosure the combination of the mesh decimation unit 11011, the mesh subdivider 11017, and the mesh fitting unit 11018 may be referred to as a pre-processor. According to embodiments, the pre-processor may further include a displacement vector calculator.

Further, the pre-processor may perform parameterization to generate vertex-wise texture coordinates and texture connectivity information for the decimated mesh (i.e., the base mesh). For example, parameterization is the process of mapping the 3D surface of the decimated mesh to a texture domain. If the parameterization is performed using the UV Atlas tool, mapping information for identifying where each vertex of the decimated mesh may be mapped on a 2D image is generated. The mapping information is represented and stored as texture coordinates. Through this process, the final base mesh is generated. The final base mesh (i.e., the decimated mesh with texture coordinates). The final base mesh (with texture coordinates) is input to the mesh subdivider 11017 and may be subdivided.

According to embodiments, the base mesh from the mesh quantizer 11012 may be output to a motion vector encoder 11014 or a static mesh encoder 11015 through a switching unit 11013.

According to embodiments, when inter-frame encoding (inter-encoding) is performed on the mesh frame, the base mesh is output to the motion vector encoder 11014 through the switching unit 11013. When intra-frame encoding (intra-encoding) is performed on the mesh frame, the base mesh is output to the static mesh encoder 11015 through the switching unit 11013. The motion vector encoder 11014 may be referred to as a motion encoder.

For example, when intra-encoding (intra-frame encoding) is performed on the mesh frame, the base mesh may be compressed through the static mesh encoder 11015. In this case, the connectivity information, vertex geometry information, vertex texture information, normal information, and the like related to the base mesh may be encoded. The base mesh bitstream generated through the encoding is transmitted to the multiplexer (not shown).

As another example, when inter-encoding (inter-frame encoding) is performed on the mesh frame, the motion vector encoder 11014 may receive as input a base mesh and a reference reconstructed base mesh (or a reconstructed quantized reference base mesh), compute a motion vector between the two meshes, and encode the value thereof. Further, the motion vector encoder 11014 may perform connectivity information-based prediction using the previously encoded/decoded motion vector as a predictor, and encode a difference motion vector (also referred to as a residual motion vector), which is obtained by subtracting the predicted motion vector from the current motion vector. The motion vector bitstream generated through the encoding is transmitted as the base mesh bitstream to the multiplexer (not shown). That is, in the case of intra-frame encoding, the static mesh bitstream is input to the multiplexer as the base mesh bitstream. In the case of inter-frame encoding, the motion vector bitstream is input to the multiplexer as the base mesh bitstream.

According to embodiments, the motion vector encoder 11014 may calculate motion vectors or difference motion vectors on a subgroup basis.

The operations of dividing subgroups and acquiring (difference) motion vectors on a per-subgroup basis by the motion vector encoder 11014 proposed in the present disclosure will be described in detail later.

In this regard, the subgroup division information output from the motion vector encoder 11014 is encoded by the auxiliary information encoder 11016 as auxiliary information. According to embodiments, the subgroup division information may include a subgroup division method. Depending on the subgroup division method, it may further include information such as the initial cluster number (in the case of K-means clustering), a cluster level (in the case of hierarchical clustering), or an octree structure (in the case of octree splitting).

According to embodiments, the auxiliary information encoder 11016 may encode the auxiliary information and output an auxiliary information bitstream to the multiplexer (not shown).

According to embodiments, the auxiliary information may further include auxiliary patch information. According to embodiments, the auxiliary patch information may include an index (cluster index) for identifying the projection plane (normal), a 3D spatial position of a patch (e.g., a tangent direction minimum value of the patch (patch 3d shift tangent axis), a bitangent direction minimum value of the patch (patch 3d shift bitangent axis), a normal direction minimum value of the patch (patch 3d shift normal axis)), a 2D spatial position and size of the patch (e.g., a horizontal size (patch 2d size u), a vertical size (patch 2d size v), a horizontal minimum value (patch 2d shift u), a vertical minimum value (patch 2d shift u)), mapping information about each block and patch (e.g., candidate index (Note that when the patches are ordered based on the 2D spatial position and size information about the patches,, multiple patches may be mapped to a block. In this case, the mapped patches constitute a candidate list, and the index indicates the patch whose data is present in the block)), and a local patch index (an index indicating one of the patches that are present in the frame). In other words, patches may be generated for 2D image mapping of mesh data, and auxiliary patch information may be generated as a result of the patch generation. The auxiliary patch information may be used in the geometry reconstruction process. The generated patches may be mapped onto a 2D image through a patch packing process.

In one embodiment of the present disclosure, the patch generation and patch packing may

be performed during the parameterization of the pre-processor.

In FIG. 15, the mesh reconstructor 11020 may receive the base mesh encoded by the static mesh encoder 11015 or the motion vectors encoded by the motion vector encoder 11014, and may generate a reconstructed base mesh. For example, the mesh reconstructor 11020 may reconstruct the base mesh by performing static mesh decoding on the base mesh encoded by the static mesh encoder 11015. In this case, quantization may be applied before the static mesh decoding, and inverse quantization may be applied after the static mesh decoding. Alternatively, the mesh reconstructor 11020 may reconstruct the base mesh based on the reconstructed quantized reference base mesh and the motion vectors encoded by the motion vector encoder 11014. The reconstructed base mesh is output to the displacement vector calculator 11019 and the texture map generator 11022.

According to embodiments, the displacement vector calculator 11019 may perform mesh subdivision on the reconstructed base mesh. Further, the displacement vector calculator 11019 may calculate a displacement vector, which is the value of the difference in vertex position between the subdivided reconstructed base mesh and the fitted subdivided mesh generated by the mesh fitting unit 11018. In this case, displacement vectors as many as vertices in the subdivided mesh may be calculated. The displacement vector calculator 11019 may transform the displacement vectors calculated in the 3D Cartesian coordinate system to a local coordinate system that is based on the normal vector of each vertex.

According to embodiments, the displacement vector calculator 11019 or a displacement vector video generator (not shown) provided between the displacement vector calculator 11019 and the displacement vector video encoder 11021 may include a linear lifting part, a quantizer, and an image packing part. In this case, the linear lifting unit may transform the displacement vectors for effective encoding. According to embodiment, the transform applied may be lifting transform wavelet transform, or the like. In addition, the quantizer may perform quantization on the transformed displacement vector values, i.e., the transform coefficients. In this case, different quantization parameters may be applied to the axes of the transform coefficients, respectively. The quantization parameters may be derived by an agreement between the encoder/decoder. After the transform and quantization, the displacement vector information may be packed into a 2D image by the image packer. The displacement vector video generator may generate a displacement vector video by grouping the packed 2D images for each frame. A displacement vector video may be generated for each group of frames (GoF) of the input mesh.

According to embodiments, the displacement vector video encoder 11021 may encode the generated displacement vector video using a video compression codec. The generated displacement vector video bitstream is transmitted to a multiplexer (not shown). According to embodiments, regarding selection of the displacement vector video encoder 11021, a displacement vector video encoder agreed upon by the encoder (i.e., the transmitting side) and the decoder (i.e., the receiving side) may be used, or the encoder on the transmitting side may analyze the characteristics of the displacement vectors and transmit the type of selected displacement vector encoder to the decoder on the receiving side. According to embodiments, the displacement vector video encoder 11021 may transform and quantize the input displacement vector.

According to embodiments, a displacement vector reconstructor may be further provided between the displacement vector video encoder 11021 and the texture map generator 11022.

According to embodiments, the displacement vector reconstructor may include a video decoder, an image unpacker, an inverse quantizer, and an inverse linear lifting unit. That is, in the displacement vector reconstructor, the encoded displacement vector is decoded by the video decoder, image unpacking is performed by the image unpacker, inverse quantization is performed by the inverse quantizer, and inverse transform is performed by the inverse linear lifting unit to reconstruct displacement vectors. Further, the displacement vector reconstructor may reconstruct a deformed mesh based on the reconstructed displacement vectors and the base mesh reconstructed by the mesh reconstructor 11020. The reconstructed mesh (also referred to as the reconstructed deformed mesh) has reconstructed vertices, inter-vertex connectivity information, texture coordinates, and inter-texture coordinate connectivity information.

According to embodiments, the texture map generator 11022 may regenerate a texture map based on the texture map (or attribute map) of the original mesh and the base mesh reconstructed by the mesh reconstructor 11020 (or the deformed mesh reconstructed by the displacement vector reconstructor). According to embodiments, the texture map generator 11022 may assign the vertex-specific color information in the texture map of the original mesh to the texture coordinates of the reconstructed base mesh (or reconstructed deformed mesh). According to embodiments, the texture map generator 11022 may generate a texture map video by grouping the frame-level regenerated texture maps into GoFs.

According to embodiments, the texture map video generated by the texture map generator 11022 may be encoded using a video compression codec of the texture map video encoder 11023. A texture map video bitstream generated through the encoding is transmitted to the multiplexer (not shown).

According to embodiments, the type of the texture map video encoder may include a video encoder (e.g., VVC, HEVC, etc.) and an entropy coding-based encoder. Regarding selection of the texture map video encoder, a texture map video encoder agreed upon by the encoder (i.e., the transmitting side) and the decoder (i.e., the receiving side) may be used, or the encoder on the transmitting side may analyze the characteristics of the texture map video encoder and transmit the type of the selected texture map video encoder to the decoder on the receiving side.

According to embodiments, the multiplexer may multiplex the input auxiliary information bitstream, base mesh bitstream, displacement vector bitstream, and texture map bitstream into a single bitstream, which may then be transmitted to the receiving side through the transmitter (not shown). Alternatively, the auxiliary information bitstream, base mesh bitstream, displacement vector bitstream, and texture map bitstream may be encapsulated into a file/segment and transmitted to the receiving side through the transmitter.

Hereinafter, a detailed description will be given of calculating and transmitting motion vectors or difference motion vectors on a per-subgroup basis.

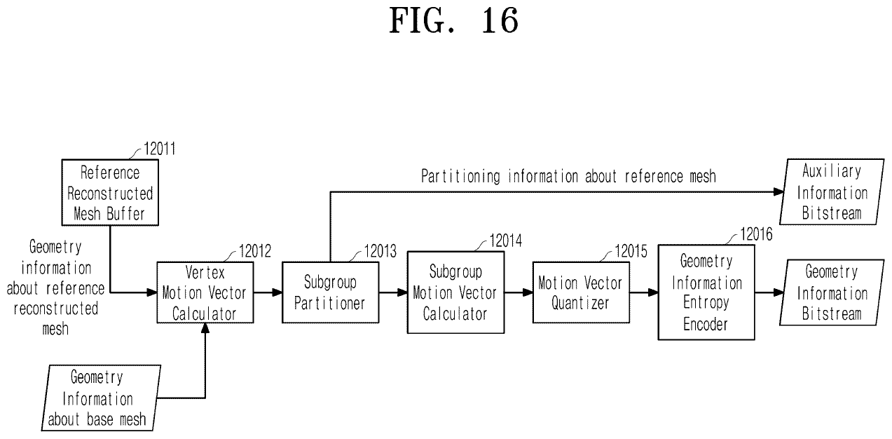

FIG. 16 is an exemplary detailed block diagram of a motion vector encoder according to embodiments. That is, FIG. 16 is an example of the motion vector encoder 11014 shown in FIG. 15. Each component in FIG. 16 corresponds to hardware, software, a processor, and/or a combination thereof. In FIG. 16, the execution order of the blocks may be changed, some blocks may be omitted, and new blocks may be added.

In FIG. 16, in one embodiment, the vertex motion vector calculator 12012 may receive geometry information about the reference reconstructed base mesh from the reference reconstructed mesh buffer 12011 and geometry information about the quantized base mesh from the mesh quantizer 11012, calculate a motion vector per vertex, and outputs the same to the subgroup partitioner 12013.

In this case, since the input base mesh (e.g., quantized base mesh) and the reference base mesh (e.g., reference reconstructed base mesh) have a one-to-one correspondence between vertices, the motion vector may be obtained based on the difference in geometry information between the input base mesh and the reference base mesh that have the same index. In the present disclosure, the reference reconstructed base mesh may have the same meaning as and be used interchangeably with the reconstructed quantized reference base mesh, reconstructed reference mesh, or reference base mesh.

According to embodiments, the subgroup partitioner 12013 may partition the reference base mesh (or the geometry information about the reference base mesh) into subgroups of similar objects based on the similarity or distance, such as similarity in motion vectors of vertices and geometry information about the vertices. In this case, the subgroup partitioning by the subgroup partitioner 12013 is calculated in the encoder (e.g., motion vector encoder) based on the partitioning method. And the corresponding subgroup partitioning information may be signaled or the subgroup partitioning information may be derived in the same manner by the encoder (i.e., the motion vector encoder on the transmitting side)/decoder (i.e., the motion vector decoder on the receiving side) based on the reconstructed geometry information of the reconstructed reference mesh (i.e., reference base mesh) or the reconstructed motion vectors.

According to embodiments, the subgroup partitioner 12013 may determine subgroups based on the order of vertices in the base mesh or the order in which the motion vectors are coded, and partition the reference base mesh into the determined subgroups. In this case, the size of the subgroups may be pre-defined according to an agreement between the encoder/decoder. Alternatively, the size of the subgroups may be signaled and transmitted to the decoder of the reception device.

Various subgroup partitioning methods may be applied. According to embodiments, the subgroup partitioning methods include octree partitioning, K-means clustering, hierarchical clustering, Kd-tree partitioning, patch segmentation.

According to embodiments, for the subgroup partitioning method, the same partitioning method agreed upon by the encoder on the transmitting side and the decoder on the receiving side may be selected, and/or the encoder on the transmitting side may add the index information related to the selected partitioning method (e.g., partition_type_idx) to the auxiliary header and transmit the same to the decoder on the receiving side. In the latter case, the decoder on the receiving side may identify the partitioning method based on the index information and partition the reference base mesh into subgroups based on the identified partitioning method, and reconstruct motion vectors.

According to embodiments, when performing the partitioning by the subgroup partitioner 12013, the partitioning method and the basis on which the partitioning is derived may vary depending on the frame type of the reference base mesh.

According to embodiments, the partitioning method may be implicitly determined based on the frame type of the reference base mesh (e.g., I-frame, P-frame, or B-frame). That is, different data may be used in the partition process depending on the frame type of the reference base mesh.

For example, when the frame type of the reference base mesh is B-frame or P-frame, the mesh may be partitioned based on the reconstructed motion vectors of the reference base mesh. When the reference base mesh is I-frame, the mesh may be partitioned based on the reconstructed vertex geometry information related to the reference base mesh. In other words, when the encoder/decoder derives the same subgroup partitioning information using the same method, the partitioning may be performed based on the reconstructed motion vectors when the reference base mesh is a B-frame or P-frame. When the reference base mesh is an I-frame, the partitioning may be performed based on the reconstructed vertex geometry information related to the reference base mesh.

In other words, the target for partitioning into subgroups depends on whether the reference base mesh is an I-frame or a P- or B-frame. When the reference base mesh is an I-frame, it does not have motion vector information, and thus the target for the partitioning is the vertex geometry information. When the reference base mesh is a P-frame or B-frame, the target for the partitioning is the motion vectors.

Next, each subgroup partitioning method is described below.

### 1) Partitioning Method Example 1 (Octree Partitioning)

When the subgroup partitioning method is octree partitioning, the subgroup partitioner 12013 may recursively partition the cuboid and determine whether to perform the partitioning based on the minimum number of vertices in the partitioned region, the distribution of vertices in the partitioned region, and the like.

Then, the rate-distortion may be calculated based on the motion vectors, and the octree partitioning may be calculated based on the result of the rate-distortion. Then, the subgroup partitioning information may be signaled. In other words, in the octree partitioning process, the distribution of values of the motion vectors partitioned into the same subgroup may be checked to determine whether they are similar. If the values are similar, further partitioning to lower levels may not be performed; if they are not similar, the operation of recursive partitioning to lower levels may be performed. This process is repeated. Then, in the final partitioned octree structure, each cuboid will represent one subgroup.

According to embodiments, when the partitioning method is the octree partitioning, the octree partitioning information (e.g., octree_partitioning_data) may be included in the auxiliary information header and transmitted to the receiving side.

According to embodiments, the signaling of the partitioning information about a space that does not have vertices that may be derived based on the geometry information about the reference base mesh may be omitted in the transmitting side. In other words, the partitioning information may not be transmitted to the receiving side.

Additionally, the bounding box size of the octree may be derived by the encoder/decoder in the same manner based on the geometry information about the reference base mesh.

### 2) Partitioning Method Example 2 (K-Means Clustering)

According to embodiments, when the subgroup partitioning method is K-means clustering, the process of calculating the distance between the centroid of each cluster and each vertex or motion vector and forming a cluster of vertices or motion vectors that are close to each other may be performed iteratively.

In the K-means clustering, when the reference base mesh is a P-frame or B-frame, the encoder on the transmitting side may calculate the initial number of clusters based on the motion vectors of the reference base mesh. The initial number may be derived by the encoder/decoder. Additionally/alternatively, after the encoder on the transmitting side sets the initial number of clusters, the set cluster number information (e.g., number_of_cluster) may be included in the auxiliary header and transmitted to the decoder on the receiving side.

If the reference base mesh is an I-frame, the encoder on the transmitting side may calculate the initial number of clusters based on the vertex geometry information about the reference base mesh, and transmit the calculated cluster number information (e.g., number_of_cluster) in the auxiliary header to the decoder on the receiving side. Additionally/alternatively, a fixed number of clusters may be used by the encoder/decoder.

In one embodiment, the distance (e.g., geodesic distance, Euclidean distance, etc.) between the centroid of the initialized cluster and each vertex may be calculated to form clusters of vertices that are close to each other. In the present disclosure, the term “cluster” may have the meaning as a subgroup. Also, the initial number of clusters may have the meaning as the number of clusters.

As such, when the reference base mesh is a P-frame or B-frame, the initial number of clusters may be derived using the motion vectors of the reference base mesh. For example, the distribution of the motion vectors may be calculated, and the initial number of clusters may be derived based on the characteristics of the distribution. The initial number of clusters represents how many clusters should be set in the K-means clustering process. Based on the initial number of clusters, the number of subgroups to be partitioned may be determined.

Further, when the reference base mesh is an I-frame, the method of calculating the initial number of clusters may include calculating the distribution of the vertex geometry information, i.e., the distribution of vertex coordinates related to the reference base mesh, and deriving the number of clusters based on the characteristics of the distribution. Alternatively, the initial number of clusters may be determined by user parameters (encoder parameters).

### 3) Partitioning Method Example 3 (Hierarchical Clustering)

According to embodiments, when the subgroup partitioning method is hierarchical clustering, all vertices or motion vectors may be set as a single cluster in a top-down manner, and then clusters with high similarity may be sequentially merged for clustering. Alternatively, each vertex or motion vector may be set as a single cluster in a bottom-up manner, and then clusters with high similarity may be sequentially merged into one cluster. In this case, in the initial process of hierarchical clustering, each entity may be initially set as a single cluster, and then the clustering process may be performed sequentially. Clusters obtained through final clustering may become subgroups.

For example, when the reference base mesh is a P-frame or B-frame, it may be initialized to form one group per vertex, and then clustering may be performed by merging vertices with similar motion vectors. As another example, when the reference base mesh is an I-frame, it may be initialized to form one group per vertex, and then clustering may be performed by merging similar vertices.

In this case, information about the hierarchical level (or cluster level) may be derived by the encoder/decoder. Alternatively, the encoder may set the hierarchical level (or cluster level), and then transmit the cluster level information (e.g., level_of_cluster) in the auxiliary information header to the decoder on the receiving side.

Here, the hierarchical level may be used interchangeably with the cluster level. That is, the hierarchical level (e.g., level_of_cluster) refers to the final depth at which the hierarchical clustering is performed. Additionally, the hierarchical level may not be transmitted if the encoder/decoder uses a fixed hierarchical level.

### 4) Partitioning Method Example 4 (Patch Segmentation)

When the subgroup partitioning method is patch segmentation, one or more patches may be formed into a single subgroup. A patch may be a set of faces or may be a connected component in texture coordinate space. In other words, one or more patches may represent a single subgroup.

According to embodiments, the encoder may calculate the rate-distortion based on the vertex geometry or motion vectors of the reference base mesh, partition the reference base mesh into patches based on the rate-distortion calculation, and signal the patch segmentation information (e.g., patch parameter set).

Here, a patch may be a set of vertex geometry information about one or more vertices or a set of motion vectors of the one or more vertices. Further, a patch may be a set of one or more texture coordinates or a set of faces.

According to embodiments, the encoder may add patch segmentation information, such as the number of patches (e.g., number_of_patch) per patch group of one or more patches to the patch parameter set to be transmitted to the decoder on the receiving side.

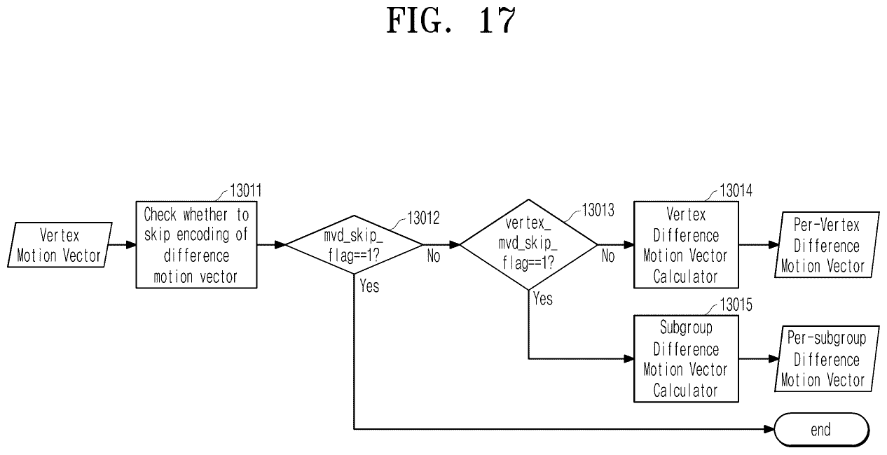

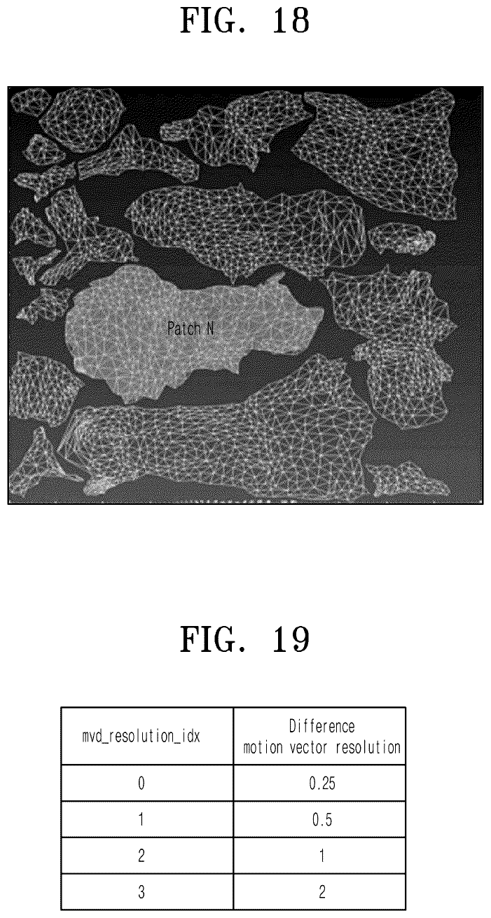

FIG. 18 illustrates an example of an N-th patch in texture space according to embodiments. In this case, a patch may be a connected component in texture coordinate space, or may be given as shown in FIG. 18.

Here, the patches may be packed/unpacked in various orders (e.g., raster scan order, zigzag scan order, etc.).

According to embodiments, the subgroup partitioner 12013 may determine the subgroups based on the vertex order of the base mesh or the order in which the motion vectors are coded. In this case, the size of the subgroups may be defined according to the agreement between the encoder/decoder. Alternatively, the size of the subgroups may be included in the subgroup partitioning information and transmitted to the decoder of the reception device. In the latter case, the decoder of the reception device may determine the size of the subgroups by parsing the signaling information including the subgroup partitioning information.

As described above, the subgroup partitioner 12013 partitions the reference base mesh into one or more subgroups. Then, the subgroup partitioning information, which includes the partitioning method, is encoded through the auxiliary information encoder, and then an auxiliary information bitstream related thereto is output.

According to embodiments, the subgroup motion vector calculator 12014 may determine whether to skip the (difference) motion vector for each subgroup and/or vertex. Based on the determination, it may either calculate and transmit the (difference) motion vector for each subgroup and/or vertex or skip the transmission. For example, when the skip is determined, the motion vectors for all vertices in the subgroup may be set to the zero vector. In other words, when the skip is determined, the corresponding (difference) motion vectors are not transmitted to the receiving side.

According to embodiments, the encoder signals skip flag information (or skip flag) indicating whether to skip the (difference) motion vectors. In the present disclosure, two pieces of skip flag information items may be signaled, which for simplicity, may be referred to as first skip flag information (e.g., mvd_skip_flag) and second skip flag information (e.g., vertex_mvd_skip_flag). This is merely an embodiment, and only one of the two pieces of skip flag information may be signaled.

That is, based on the motion vectors of the subgroup or the vertices within the subgroup, rate-distortion may be calculated. Based on the result of the calculation, the skip flag may be transmitted per subgroup or vertex, and the (difference) motion vector may not be transmitted. Here, the calculation of the rate-distortion based on the motion vectors of the subgroup or the vertices within the subgroup is intended to determine whether the motion vectors of the vertices within the subgroup are similar.

Various methods may be used to calculate the rate-distortion based on the motion vectors of the subgroup or the vertices within the subgroup. For example, the rate-distortion cost may be calculated based on the difference in point cloud-based D1-PSNR and D2-PSNR and the number of bits between the case where the motion vectors of the vertices within the subgroup are not transmitted and the case where the motion vectors are transmitted.

According to embodiments, the distribution of the motion vectors within the subgroup may be calculated. When the variance is small, it may be determined that the motion vectors within the subgroup are similar.

According to embodiments, the encoder may signal the first skip flag information (e.g., mvd_skip_flag). The first skip flag information may be referred to as a (difference) motion vector skip flag for the subgroup and vertices. According to the present disclosure, based on the first skip flag information (e.g., mvd_skip_flag), the transmission of the per-subgroup (difference) motion vector and the (difference) motion vectors of the vertices may be skipped. In this case, the decoder of the reception device may derive the per-subgroup (difference) motion vector and the (difference) motion vectors of vertices as zero vectors.

According to embodiments, the encoder may signal the second skip flag information (e.g., vertex_mvd_skip_flag). The second skip flag information may be referred to as a difference motion vector skip flag for the vertices. Based on the second skip flag information (e.g., vertex_mvd_skip_flag), the transmission of the per-vertex (difference) motion vector may be skipped.

According to embodiments, based on at least one of the first skip flag information (e.g., mvd_skip_flag) and the second skip flag information (e.g., vertex_mvd_skip_flag), a (difference) motion vector or the like per subgroup may be transmitted to the reception device.

According to embodiments, the encoder parameters may be transmitted on a per-tile or slice basis.

In the present disclosure, tiles/slices may be units for partitioning dynamic mesh data and independently encoding/decoding the partitioned regions.

According to embodiments, a tile/slice may be composed of one or more subgroups.

According to embodiments, the encoder may transmit various encoding parameters, such as motion vector resolution information (e.g., mvd_resolution_idx) and a quantization parameter per partition unit (e.g., patch group, subgroup, slice, tile, etc.) to the decoder of the reception device.

FIG. 17 is a diagram illustrating an example of the process of checking whether to skip a motion vector and calculating a motion vector according to the embodiments. That is, FIG. 17 illustrates an example of the detailed operation of the subgroup motion vector calculator 12014 in FIG. 16. In FIG. 17, the execution order of the blocks may be changed, some blocks may be omitted, and new blocks may be added.

That is, the vertex motion vectors calculated by the vertex motion vector calculator 12012 are input to the subgroup motion vector calculator 12014 on a subgroup-by-subgroup or vertex-by-vertex basis.

According to embodiments, the subgroup motion vector calculator 12014 may check whether to skip encoding of the difference motion vector (13011), and based on the result of the checking, and calculate a difference motion vector of the subgroup, which is the difference between the motion vector of the subgroup and the predicted motion vector of the subgroup.

According to embodiments, whether to skip encoding of the difference motion vector may be determined based on at least one of the first skip flag information (e.g., mvd_skip_flag) and the second skip flag information (e.g., vertex_mvd_skip_flag).

In FIG. 17, in one embodiment, when the value of the first skip flag information (e.g., mvd_skip_flag) is 1 (13012), the transmission of the difference motion vector of the subgroup may be skipped. In this case, the motion vector for all vertices in the subgroup may be determined to be the zero vector (0, 0, 0) according to one embodiment. Also, in one embodiment, when the value of the first skip flag information (e.g., mvd_skip_flag) is 1 (13012), the transmission of the difference motion vector for the vertex may be skipped. In this case, the motion vector for the vertex may be determined to be the zero vector (0, 0, 0) according to one embodiment.

When the value of the first skip flag information (e.g., mvd_skip_flag) is 0 (13012), the value of the second skip flag information (e.g., vertex_mvd_skip_flag) is checked to determine when it is 1 or 0 (13013).

In one embodiment, when the value of the second skip flag information (e.g., vertex_mvd_skip_flag) is 1 (13015), the subgroup motion vector calculator 12014 may calculate the difference motion vector on a per-subgroup basis. When the value is 0, the calculator may calculate the difference motion vector on a per-vertex basis and output the same (13014).

According to embodiments, for the motion vector for a subgroup, the subgroup difference motion vector calculator 13015 may obtain the average of the motion vectors of the vertices in the subgroup as a representative value of the motion vectors of the vertices in the subgroup. In other words, the average of the motion vectors of the vertices in the current subgroup may be used as the motion vector for the current subgroup.

According to embodiments, the subgroup difference motion vector calculator 13015 may calculate a predicted motion vector for the subgroup based on the motion vectors of the neighbor vertices that were decoded earlier in the current frame or the motion vectors of the reference frame.

For example, the predicted motion vector of the subgroup may be obtained through prediction based on the motion vector of a subgroup spatially close to the current subgroup among the subgroups reconstructed earlier, or the average motion vector of the N vertices closest to the vertices of the current subgroup. In other words, the motion vector of the subgroup that is spatially close to the current subgroup among the subgroups reconstructed earlier may be used as the predicted motion vector of the current subgroup, or the average motion vector of the N vertices closest to the vertices of the current subgroup may be used as the predicted motion vector of the current subgroup.

Also, when the reference base mesh is a P-frame or B-frame, the average motion vector of the reference base mesh vertices with the same index as the current base mesh vertices may be used as the predicted motion vector of the current subgroup.

According to embodiments, the subgroup difference motion vector calculator 13015 may calculate the difference motion vector of the subgroup as the difference between the motion vector of the subgroup and the predicted motion vector of the subgroup. That is, the difference motion vector of the current subgroup is acquired by subtracting the predicted motion vector of the current subgroup from the motion vector of the current subgroup.

According to embodiments, the vertex difference motion vector calculator 13014 may calculate a difference motion vector per vertex by obtaining the difference between the predicted motion vector of the vertex and the motion vector of the vertex in the subgroup. Here, the motion vector of the vertex in the subgroup is the motion vector calculated by the vertex motion vector calculator 12012.

According to embodiments, when the motion vectors of the vertices in the subgroup are not similar to each other, the vertex difference motion vector calculator 13014 calculates the difference motion vector for each vertex. That is, when the value of the first skip flag information (e.g., mvd_skip_flag) is 0, and the value of the second skip flag information (e.g., vertex_mvd_skip_flag) is 0, it may be determined that the motion vectors of the vertices in the subgroup are not similar to each other.

The vertex difference motion vector calculator 13014 may calculate the predicted motion vector of a vertex in the subgroup based on the previously reconstructed vertex motion vectors. In this case, prediction may be performed by the average of the motion vectors or parallelogram prediction or the average of multiple parallelogram predictions of adjacent vertices based on connectivity information.

According to embodiments, the second skip flag information (e.g., vertex_mvd_skip_flag) may be omitted. In this case, based on the first skip flag information (e.g., mvd_skip_flag), the difference motion vector of the subgroup may either be skipped or transmitted. For example, the first skip flag information (e.g., mvd_skip_flag) is signaled for each subgroup. When the value of the first skip flag information (e.g., mvd_skip_flag) is 1, the motion vectors for all vertices in the corresponding subgroup may be determined to be the zero vector (0, 0, 0) (i.e., skipped). In other words, when the second skip flag information (e.g., vertex_mvd_skip_flag) is omitted, the decoder of the reception device may receive the motion vectors parsed on a per-vertex basis and perform inverse quantization on the vertex (difference) motion vectors.

According to embodiments, the per-vertex difference motion vector or per-subgroup difference motion vector output from the subgroup motion vector calculator 12014 is quantized by the motion vector quantizer 12015 and then output to the geometry information entropy encoder 12016. In the present disclosure, the motion vector quantizer 12015 may be omitted.

According to embodiments, the geometry information entropy encoder 12016 may perform entropy encoding on the subgroup difference motion vector transmission skip flag (e.g., the first skip flag information), the vertex difference motion vector transmission skip flag (e.g., the second skip flag information), difference motion vectors per subgroup, difference motion vectors per vertex, and the like, and output a geometry information bitstream. In the present disclosure, the geometry information bitstream may be referred to as a base mesh bitstream or a motion vector bitstream.

According to embodiments, the geometry information entropy encoder 12016 may encode the subgroup difference motion vector transmission skip flag (e.g., the first skip flag information), the vertex difference motion vector transmission skip flag (e.g., the second skip flag information), the per-subgroup difference motion vector, and the per-vertex difference motion vector using various encoding methods such as Context-Adaptive Binary Arithmetic Coding (CABAC), Exponential Golomb, Variable Length Coding (VLC), or Context-Adaptive Variable Length Coding (CAVLC). In the present disclosure, the type of the entropy encoder/decoder may be determined by an agreement between the encoder (i.e., the transmitting side)/the decoder (i.e., the receiving side), or the reception device may determine the encoder/decoder type determined by the encoder of the transmission device by receiving and parsing a bitstream.

Next, the method of selecting the resolution of the difference motion vector will be described.

When performing difference motion vector encoding, the motion vector encoder 11014 may select the resolution of the difference motion vector on a per-subgroup basis.

Then, an index for the difference motion vector resolution (e.g., mvd_resolution_idx) may be signaled per subgroup. In the present disclosure, the index for the difference motion vector resolution (e.g., mvd_resolution_idx) may be referred to as motion vector resolution information.

According to embodiments, the motion vector resolution index per higher-level unit (e.g., slice, tile, patch group, etc.) may be signaled. Thus, for a subgroup for which the motion of the unit is small, a higher resolution of the difference motion vector may be selected. For a subgroup for which the motion is large, a lower resolution may be selected for the difference motion vector.

The motion vector resolution may be selected on a per-subgroup basis or on a per-vertex motion vector basis.

Further, the resolution of the difference motion vector may be the same for the x, y, and z components of the motion vector, or different resolutions may be selected for the components, respectively.

FIG. 19 shows examples of motion vector resolutions according to motion vector resolution information according to the embodiments. That is, FIG. 19 shows examples of the difference motion vector resolution index (i.e., motion vector resolution information) based on the resolution of the difference motion vector. For example, the motion vector resolution information (mvd_resolution_idx) set to 0 may indicate that the difference motion vector resolution equal to 0.25 is selected. The motion vector resolution information (mvd_resolution_idx) set to 1 may indicate that the difference motion vector resolution equal to 0.5 is selected. The motion vector resolution information (mvd_resolution_idx) set to 2 may indicate that the difference motion vector resolution equal to 1 is selected. The motion vector resolution information (mvd_resolution_idx) set to 3 may indicate that the difference motion vector resolution equal to 2 is selected.

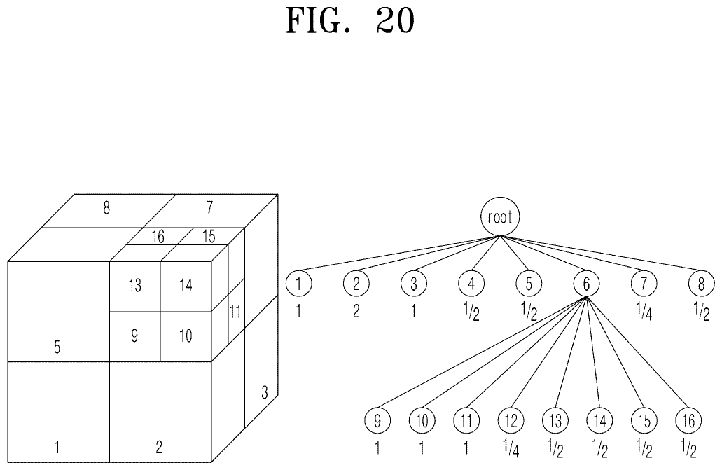

FIG. 20 is a diagram illustrating an example of motion vector resolution on a per-subgroup basis in an octree structure according to embodiments. That is, FIG. 20 illustrates an example of configuring a motion vector resolution index on a per-subgroup basis when the subgroup partitioning method is the octree partitioning.

In the present disclosure, the resolution of a motion vector refers to the precision of the motion vector.

For example, when the motion vector resolution information (mvd_resolution_idx) is 3 (i.e., the difference motion vector resolution equal to 2 is selected), it means that in the decoding process of the motion vector on the reception device, decoding is performed with twice the value of the decoded motion vector. For example, when the motion is large, namely, the motion vector has a large resolution, the motion vector encoder 1104 may lower the motion vector resolution to encode with fewer bits.

On the other hand, when the motion vector resolution information (mvd_resolution_idx) is 1, i.e., when the difference motion vector resolution equal to ½ is selected, it means that the reception device performs decoding with half the value.

In the present disclosure, whether the motion is large or small may be determined based on the motion vector values per subgroup.

Further, the (difference) motion vector resolution may be determined differently for each subgroup generated using not only the octree partitioning but also various partitioning methods. The motion vector resolution may be set for each subgroup based on the motion vector information (e.g., motion vector distribution, motion vector average, etc.).

The auxiliary information bitstream, base mesh bitstream, displacement vector bitstream, and texture map bitstream generated through the process described above may be multiplexed into a single bitstream by a multiplexer. Then, it may be transmitted over a network, or stored on a digital storage medium. Here, the network may include a broadcast network and/or a communication network, and the digital storage medium may include various storage media such as USB, SD, CD, DVD, Blu-ray, HDD, and SSD.

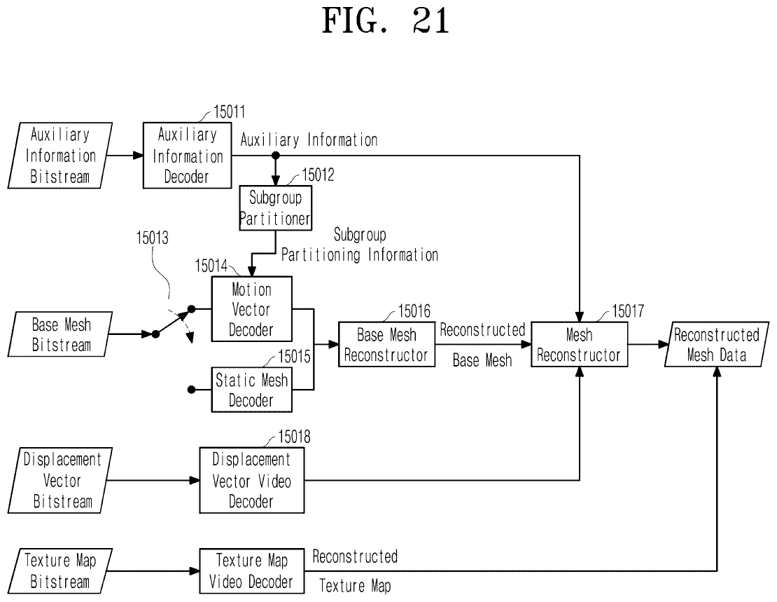

FIG. 21 illustrates a mesh data reception device according to embodiments. In the present disclosure, the reception device of FIG. 21 may be referred to as a decoder.

FIG. 21 corresponds to the reception device 110 or mesh video decoder 113 of FIG. 1, the decoder of FIG. 11 or 12, the reception device of FIG. 14, and/or a corresponding reception decoding device. Each of the components of FIG. 21 corresponds to hardware, software, a processor, and/or a combination thereof. The reception (decoding) operation in FIG. 21 may follow the reverse process to the corresponding process of the transmission (encoding) operation in FIG. 15. In FIG. 21, the execution order of the blocks may be changed, some blocks may be omitted, and new blocks may be added.

According to embodiments, the bitstream of mesh data received by a receiver (not shown) is subjected to file/segment decapsulation, and is then demultiplexed into the auxiliary information bitstream, the base mesh bitstream (or geometry information bitstream), the displacement vector bitstream, and the texture map bitstream by a demultiplexer (not shown). In the case where inter-frame encoding (i.e., inter encoding) has been applied to the current mesh, the base mesh bitstream (or geometry information bitstream) may be a motion vector bitstream.

According to embodiments, the auxiliary information decoder 15011 decodes the auxiliary information bitstream and outputs auxiliary information.

The base mesh bitstream is output to the motion vector decoder 15014 or the static mesh decoder 15015 via the switching unit 15013.

For example, in the case where inter-frame encoding (i.e., inter encoding) has been applied to the current mesh, the base mesh bitstream, i.e., the motion vector bitstream, is received, demultiplexed, and output to the motion vector decoder 15014 via the switching unit 15013. In another example, in the case where intra-frame encoding (i.e., intra encoding) has been applied to the current mesh, the base mesh bitstream is received, demultiplexed, and output to the static mesh decoder 15015 via the switching unit 15013. Here, the motion vector decoder 15014 may be referred to as a motion decoder.

According to embodiments, the motion vector decoder 15014 may decode the motion vector bitstream on a per-vertex or per-subgroup basis. To this end, the reception device may further include a subgroup partitioner 15012. The subgroup partitioner 15012 partitions the reference base mesh into subgroups based on auxiliary information, and the subgroup partitioning information included in the decoded auxiliary information is output to the motion vector decoder 15014. The detailed operation of the subgroup partitioner 15012 will be described later.

According to embodiments, the motion vector decoder 15014 may reconstruct the final motion vector by taking previously decoded motion vectors as predictors and adding the decoded difference motion vector (i.e., residual motion vector) from the bitstream thereto.

According to embodiments, the static mesh decoder 15015 may decode the base mesh bitstream to reconstruct the connectivity information, vertex geometry information, texture coordinates (i.e., attribute geometry information), normal information, and the like related to the base mesh.

According to embodiments, the base mesh reconstructor 15016 may reconstruct the current base mesh based on the decoded motion vector or the decoded base mesh. For example, in the case where inter-frame encoding has been applied to the current mesh, the base mesh reconstructor 15016 may reconstruct the base mesh by adding the decoded (or reconstructed) motion vector to the reference base mesh and performing inverse quantization. In another example, in the case where intra-frame encoding has been applied to the current mesh, the base mesh reconstructor 15016 may reconstruct the base mesh by performing inverse quantization on the base mesh decoded (or reconstructed) through the static mesh decoder 15015.

According to embodiments, the displacement vector video decoder 15018 may decode the displacement vector bitstream as a video bitstream using a video codec.

According to embodiments, types of the displacement vector video decoder 15018 may include video decoders (e.g., VVC, HEVC) and entropy coding-based decoders. For the displacement vector video decoder 15018, a displacement vector video decoder agreed upon by the encoder (i.e., the transmitting side)/the decoder (i.e., the receiving side) may be selected, or the displacement vector video decoder type determined by the encoder may be parsed to select a displacement vector video decoder.

According to embodiments, a displacement vector reconstructor may be further provided between the displacement vector video decoder 15018 and the mesh reconstructor 15017. The displacement vector reconstructor may extract displacement vector transform coefficients from the decoded displacement vector video, and apply inverse quantization and inverse transform (e.g., wavelet inverse transform) to the extracted displacement vector transform coefficients to reconstruct the displacement vector. To this end, the displacement vector reconstructor may include an image unpacker, an inverse quantizer, and an inverse linear lifting part. If the reconstructed displacement vector is in a local coordinate system, an inverse transform to the Cartesian coordinate system may be performed. Alternatively, the displacement vector video decoder 15018 may further perform the displacement vector reconstruction process described above.

The mesh reconstructor 15017 may subdivide the base mesh reconstructed by the base mesh reconstructor 15016 based on the auxiliary information to generate additional vertices. Through the subdivision, vertex connectivity information that include the added vertices, texture coordinates, and connectivity information about the texture coordinates may be generated. The mesh reconstructor 15017 may then combine the subdivided reconstructed base mesh with the reconstructed displacement vector to generate the final reconstructed mesh (also referred to as a reconstructed deformed mesh).

According to embodiments, the texture map video decoder 15019 may decode the texture map bitstream as a video bitstream using a video codec to reconstruct the texture map. The reconstructed texture map may have color information about each vertex contained in the reconstructed mesh, and may obtain the color value of each vertex from the texture map based on the texture coordinates of the vertex,.

According to embodiments, types of the texture map video decoder 15019 may include video decoders (e.g., VVC, HEVC) and entropy coding-based decoders. As a method of selecting the texture map video decoder, a texture map video decoder agreed upon between the encoder/the decoder may be used, or the decoder type determined by the encoder may be parsed to determine the texture map video decoder.

According to embodiments, the reconstructed mesh from the mesh reconstructor 15017 and the reconstructed texture map from the texture map video decoder 15019 are rendered by a mesh data renderer (not shown) and displayed for the user through the rendering process.

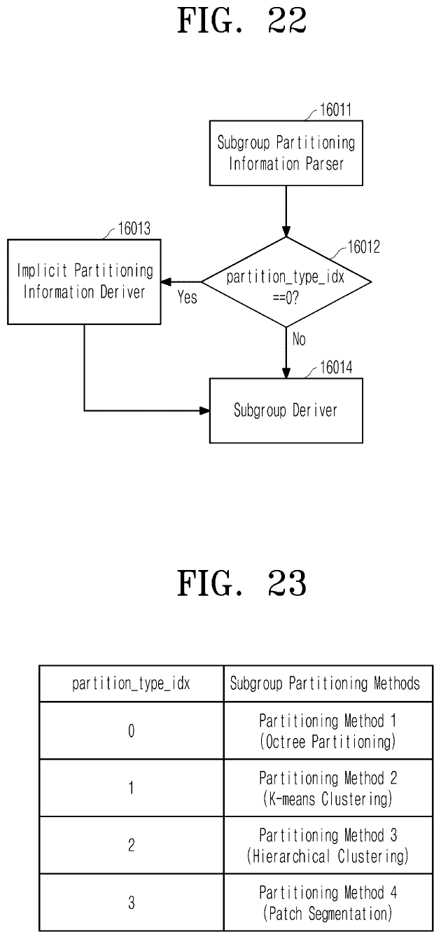

FIG. 22 is a diagram illustrating an exemplary subgroup partition process according to embodiments. In FIG. 22, the execution order of the blocks may be changed, some blocks may be omitted, and new blocks may be added.

In FIG. 22, the subgroup partitioning information parser 16011 parses the subgroup partitioning information from the decoded auxiliary information.

According to embodiments, the subgroup partitioning information may include a subgroup partitioning method (e.g., partition_type_idx), information about the subgroup partitioning method (e.g., the initial number of clusters (e.g., number_of_cluster) for K-means clustering, the cluster level (e.g., level_of_cluster) for hierarchical clustering, the octree structure (e.g., octree_partitioning_data) for octree partitioning, and the patch size (e.g., patch_parameter_set) for patch segmentation).

According to embodiments, when motion vector decoding is performed on the mesh on a per-frame basis, the mesh for a frame may be partitioned into one subgroup by the subgroup partitioner 15012.

According to embodiments, the subgroup partitioner 15012 may check the subgroup partitioning method index (i.e., partition_type_idx) included in the subgroup partitioning information (16012). Based on the depending on the subgroup partitioning method index (i.e., partition_type_idx), an implicit partitioning information derivation process may be performed (16013), and/or a subgroup derivation process may be performed (16014). FIG. 23 shows examples of a subgroup partitioning method index (i.e.,

partition_type_idx) according to embodiments. In other words, FIG. 23 illustrates an exemplary method of configuring the subgroup partitioning method index (i.e., partition_type_idx) according to the subgroup partitioning methods. For example, when partition_type_idx is set to 0, it may indicate partitioning method 1 (i.e., octree partitioning); when set to 1, it may indicate partitioning method 2 (i.e., K-means clustering); when set to 2, it may indicate partitioning method 3 (i.e., hierarchical clustering); and when set to 3, it may indicate partitioning method 4 (i.e., patch segmentation).

According to embodiments, the subgroup partitioner 15012 may use various subgroup partitioning methods. For example, the subgroup partitioner 15012 may perform partitioning using a fixed method based on the agreement between the encoder (i.e., the transmitting side)/the decoder (i.e., the receiving side) without transmitting partition_type_idx, or a specific partitioning mode may be implicitly derived according to the frame type (inter-frame or intra-frame) of the reference mesh. Additionally, as the subgroup partitioning method, only some of the various partitioning methods may be used to configure an index.

According to embodiments, the implicit partitioning information deriver 16013 may derive the partitioning information based on the geometry information about the reference mesh reconstructed by the decoder, and/or may skip transmitting partitioning information about a region where there is no vertex.

According to embodiments, the subgroup partitioner 15012 may perform the implicit partitioning information derivation process only when partition_type_idx indicates the octree partitioning as the subgroup partitioning method.

For example, when the code word for a voxel with a vertex is 1 and the code word for a voxel without a vertex is 0, the code word for regions where no vertices are present may be derived to be 0. In the present disclosure, a code word for absence of vertices is derived to be 0, such that the corresponding regions are no longer partitioned. Subgroups may be configured using the final octree structure generated through this process. For example, in the case where a vertex is present in a voxel, the operation of octree partitioning may be recursively performed until the number of vertices within the voxel is reduced to a specific number N or less. When there are no vertices in the voxel, no further partitioning is performed for the voxel.

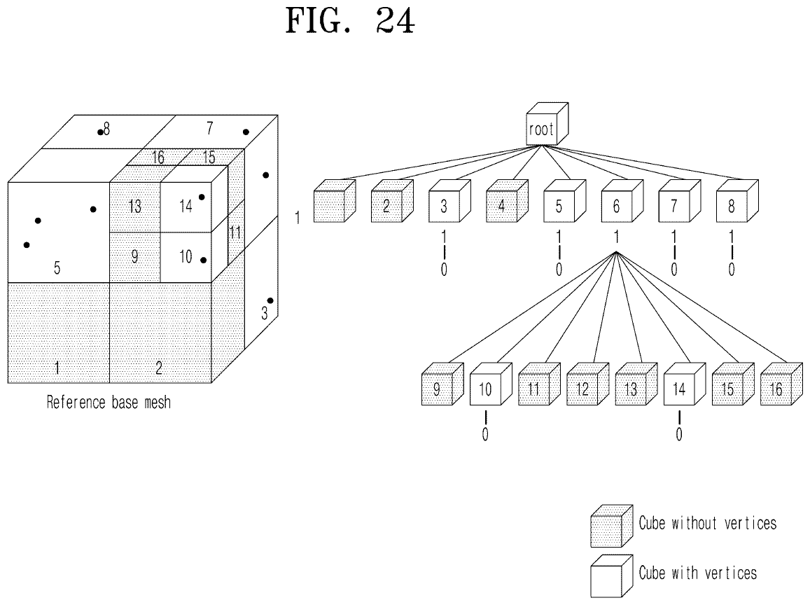

FIG. 24 is a diagram illustrating an example of deriving subgroup partitioning information from an octree structure according to embodiments. Specifically, FIG. 24 illustrates an embodiment in which implicit partitioning information is derived as 0 for regions without vertices in deriving the octree partitioning depth information.

Thus, the subgroup partitioner 15012 may derive partitioning information through the implicit partitioning information deriver 16013 when the subgroup partitioning method index (i.e., partition_type_idx) is 0, i.e., octree partitioning. In the present disclosure, the term “implicit partition derivation” means that the partitioning information (e.g., partitioned octree depth information) may be derived by the decoder of the reception device without receiving the partitioning information.

According to embodiments, when the subgroup partitioning method index (i.e., partition_type_idx) is not 0, i.e., when the method is one of K-means clustering, hierarchical clustering, or patch segmentation, the subgroup deriver 16014 may perform the subgroup partitioning.

For example, the subgroup deriver 16014 may perform the subgroup partitioning based on the subgroup partitioning information determined and signaled by the encoder of the transmission device and then parsed, or may perform the subgroup partitioning based on the per-subgroup partitioning information derived from the geometry information about the reference mesh by the decoder of the reception device. In other words, since the current base mesh and the reference base mesh have the same connectivity information, texture coordinates, and number of vertices, the partitioning structure of the current base mesh may be derived based on the reference base mesh information. Also, the subgroup partitioning information may be derived from the geometry information related to the reference mesh. According to embodiments, the subgroup partitioning method may be K-means clustering. When the reference base mesh is a P-frame or B-frame, clustering may be performed using the motion vectors of the reference base mesh. When the mesh is an I-frame, the K-means clustering process may be performed based on the vertex geometry information related to the reconstructed reference base mesh to derive the subgroup partitioning information.

As described above, in the present disclosure, after deriving the subgroup partitioning information related to the reference base mesh, the subgroup deriver 16014 may apply the derived subgroup partitioning information to the current base mesh. In this case, as a method applied, vertex index information about the vertices of the reference base mesh included in each subgroup may be mapped to the corresponding vertex indices of the current base mesh on a per-subgroup basis to partition the current base mesh into subgroups.

According to embodiments, the subgroup partitioner 15012 may obtain the subgroup partitioning method by parsing the subgroup partitioning method index (partition_type_idx) included in the auxiliary information header transmitted from the transmission device.

According to embodiments, when the subgroup partitioning method is partitioning method example 1 (octree partitioning), the subgroup deriver 16014 may perform the subgroup partitioning based on the octree partitioning information (octree_partitioning_data) included in the auxiliary information header.

According to embodiments, when the subgroup partitioning method is partitioning method example 2 (K-means clustering), the initial number of clusters may be set based on the initial cluster number information (number_of_cluster) included in the auxiliary information header, or may be set to a fixed initial number of clusters by the encoder/decoder. Then, the subgroup partitioning may be performed based on the set initial number of clusters.

When the reference mesh is a P-frame or B-frame, K-means clustering may be performed based on the motion vectors of the reconstructed reference base mesh. When the reference mesh is an I-frame, K-means clustering may be performed based on the geometry information about the reconstructed reference base mesh.

According to embodiments, when the subgroup partitioning method is partitioning method example 3 (hierarchical clustering), and the reference mesh is a P-frame or B-frame, the subgroup deriver 16014 may be initialized to form one group per vertex and then perform clustering by merging motion vectors of similar vertices. When the reference mesh is an I-frame, the subgroup deriver 16014 may be initialized to form one group per vertex and then perform clustering by merging similar vertices.

Additionally, when the subgroup partitioning method is hierarchical clustering, the cluster level may be set based on the cluster level information (level_of_cluster) included in the auxiliary information header, or may be set to a fixed cluster level by the encoder/decoder. In other words, subgroup partitioning may be performed based on the set cluster level.

According to embodiments, when the subgroup partitioning method is partitioning method example 4 (patch segmentation), patch segmentation information such as the number of patches (number_of_patch) included in the patch parameter set may be parsed per frame to perform patch segmentation.

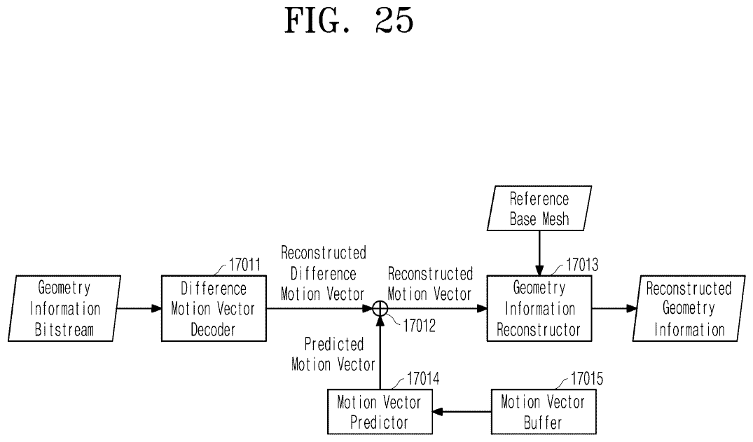

FIG. 25 is an exemplary detailed block diagram of a motion vector decoder according to embodiments. Each component in FIG. 25 corresponds to hardware, software, a processor, and/or a combination thereof. In FIG. 25, the execution order of the blocks may be changed, some blocks may be omitted, and new blocks may be added.

According to embodiments, in the case of inter-prediction, the motion vector decoder 15014 receives a geometry information bitstream (also referred to as a motion vector bitstream) transmitted from the encoder of the transmission device via the switching section 15013, decodes the bitstream on a subgroup-by-subgroup and/or vertex-by-vertex basis, and obtains a difference motion vector. Then, it adds the decoded difference motion vector and the derived predicted motion vector to reconstruct the motion vector to reconstruct the geometry information about the current base mesh based on the reconstructed motion vector. Here, the geometry information bitstream may be used interchangeably with the base mesh bitstream.

More specifically, the difference motion vector decoder 17011 decodes the geometry information bitstream to reconstruct the difference motion vectors. In this case, the difference motion vector decoder 17011 may decode the difference motion vectors on a subgroup-by-subgroup and/or vertex-by-vertex basis for the reconstruction. To this end, the subgroup partitioning information is provided to the difference motion vector decoder 17011 in the motion vector decoder 15014 via the subgroup partitioner 15012.

For example, when the value of the first skip flag information (e.g., mvd_skip_flag) is 1, the difference motion vector decoder 17011 may perform the difference motion vector decoding on a vertex-by-vertex basis.

In another example, when the value of the first skip flag information (e.g., mvd_skip_flag) is 0, the second skip flag information (e.g., vertex_mvd_skip_flag) is parsed to determine whether to decode the difference motion vectors on a per-subgroup basis or a per-vertex basis to decode the difference motion vectors. For example, when the value of the second skip flag information (vertex_mvd_skip_flag) is 1, the difference motion vectors are decoded on a per-subgroup basis. When the value of the second skip flag information (vertex_mvd_skip_flag) is 0, the difference motion vectors are decoded on a per-vertex basis.

According to embodiments, the motion vector reconstructor 17012 reconstructs the motion vectors by adding the difference motion vectors reconstructed by the difference motion decoder 17011 to the predicted motion vectors output by the motion vector predictor 17014. The detailed operation of the motion vector predictor 17014, which predicts motion vectors based on the motion vectors stored in the motion vector buffer 17015, will be described later.

According to embodiments, the geometry information reconstructor 17013 may reconstruct the geometry information about the current base mesh based on the reference reconstructed base mesh and the reconstructed motion vectors.

For example, when the motion vectors are decoded on a subgroup-by-subgroup basis, the motion vector predictor 17014 may be used to obtain predicted motion vectors on a subgroup-by-subgroup basis, and the motion vector reconstructor 17012 may reconstruct the motion vectors by adding the reconstructed difference motion vectors to the predicted motion vectors on a subgroup-by-subgroup basis. Then, the geometry information reconstructor 17013 may reconstruct the geometry information about the current base mesh by adding the reconstructed motion vectors to the vertices of the reference base mesh having the same indices as the vertices of the current base mesh.

According to embodiments, the motion vector buffer 17015 may store the motion vectors reconstructed by the motion vector reconstructor 17012. When storing the motion vectors in the motion vector buffer 17015 (i.e., memory), the bit depth of the motion vectors set to a value pre-fixed by the encoder/decoder may be used. Here, the bit depth of the motion vectors refers to the number of bits used to store each of the x, y, and z components of the motion vector (x, y, z).

According to embodiments, the bit depth pre-fixed by the encoder/decoder may be represented as an integer value. For example, the bit depth of the motion vectors may be calculated as 10 bits during the motion vector encoding/decoding process, and may be stored in the motion vector buffer 17015 as 8 bits,, i.e., a smaller amount of data.

According to embodiments, the motion vector buffer 17015 may store a motion vector per vertex.

According to embodiments, the motion vectors may be stored in the motion vector buffer 17015 after reducing the spatial resolution of the motion vectors. Additionally, the motion vector buffer 17015 may store one motion vector in an n×k×l unit.

In the present disclosure, whether to reduce the spatial resolution of motion vectors may be determined based on the size of the motion vectors, or the resolution may be reduced by calculating the rate-distortion for the motion vectors. In the present disclosure, the spatial resolution of motion vectors is not related to the resolution of difference motion vectors. That is, when transmitting (difference) motion vectors to the decoder of the reception device, the resolution of the difference motion vectors is changed to reduce the amount of bits. When storing the motion vectors in the motion vector buffer 17015 of the reception device, the spatial resolution of the motion vectors may be changed to reduce the amount of bits.

According to embodiments, the order in which the reconstructed motion vectors are stored in the motion vector buffer 17015 may be the order of reconstruction of the motion vectors. In other words, the order of reconstruction of the motion vectors may be the index order of the vertices of the current base mesh. Further, when the motion vectors are in floating point form, the motion vectors may be quantized and converted to fixed point form and stored in the motion vector buffer 17015.

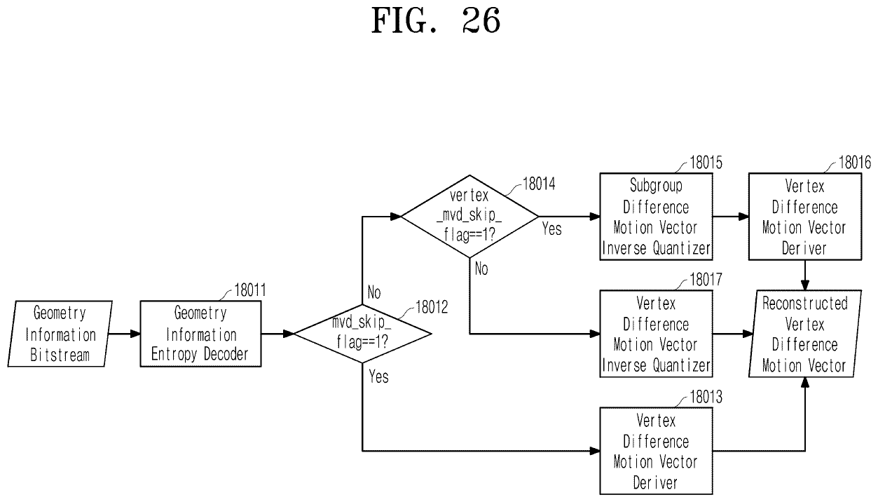

FIG. 26 is a diagram illustrating an example detailed operation of a difference motion vector decoder according to embodiments. That is, FIG. 26 is a diagram illustrating an exemplary process of decoding difference motion vectors by the difference motion vector decoder 17011. In FIG. 26, the execution order of the blocks may be changed, some blocks may be omitted, and new blocks may be added.

In FIG. 26, the geometry information entropy decoder 18011 may perform entropy decoding on the geometry information bitstream. For example, the geometry information entropy decoder 18011 may decode the geometry information bitstream using various decoding methods such as CABAC, exponential Golomb, VLC, or CAVLC. According to embodiments, the geometry information bitstream input to the geometry information entropy decoder 18011 may include a difference motion vector transmission skip flag (e.g., first skip flag information) for the subgroups, a difference motion vector transmission flag (e.g., second skip flag information) for the vertices, per-subgroup difference motion vectors, and per-vertex difference motion vectors.

In the present disclosure, the geometry information entropy decoder 18011 may be determined either by a predefined agreement between the encoder/the decoder or by parsing an index for the type of entropy decoder transmitted from the encoder.

According to embodiments, based on at least one of the entropy-decoded first skip flag information (e.g., mvd_skip_flag) (18012) and second skip flag information (e.g., vertex_mvd_skip_flag) (18014), the difference motion vector decoder 17011 may perform inverse quantization on the difference motion vectors on a per-subgroup basis and/or per-vertex basis, or perform vertex difference motion vector derivation.

For example, when the value of the first skip flag information (e.g., mvd_skip_flag) is 1, the vertex difference motion vector derivation may be performed (18013). That is, when the value of the first skip flag information (e.g., mvd_skip_flag) is 1, the transmission device skips the transmission of difference motion vectors per subgroup and difference motion vectors per vertex vertices, and thus the reception device does not receive the subgroup difference motion vectors. Since the subgroup difference motion vectors are not received (i.e., parsed), the vertex difference motion vector deriver 18013 derives the difference motion vectors of the subgroups and the vertices as zero vectors (0, 0, 0).

If the value of the first skip flag information (e.g., mvd_skip_flag) is 0, inverse quantization may be performed on the difference motion vectors on a per-subgroup basis (18015) or per-vertex basis (18017) according to the second skip flag information (e.g., vertex_mvd_skip_flag).

For example, when the value of the first skip flag information (e.g., mvd_skip_flag) is 0 and the value of the second skip flag information (e.g., vertex_mvd_skip_flag) is 1, the subgroup difference motion vector inverse quantizer 18015 may perform inverse quantization on the difference motion vectors on a per-subgroup basis. In another example, when the value of the first skip flag information (e.g., mvd_skip_flag) is 0 and the value of the second skip flag information (e.g., vertex_mvd_skip_flag) is 0, the vertex difference motion vector inverse quantizer 18017 may perform inverse quantization on the difference motion vectors on a per-vertex basis.

In the present disclosure, the subgroup difference motion vector inverse quantizer 18015 may perform inverse quantization on the difference motion vectors of the subgroups. According to embodiments, the subgroup difference motion vector inverse quantizer 18015 may be omitted. Additionally, the vertex difference motion vector inverse quantizer 18017 may perform inverse quantization on the difference motion vectors of the vertices in the subgroups. According to embodiments, the vertex difference motion vector inverse quantizer 18017 may be omitted.

According to embodiments, vertex difference motion vectors are derived by the vertex difference motion vector deriver 18016 based on the difference motion vectors that have been inversely quantized on a per-subgroup basis by the difference motion vector inverse quantizer 18015, and then reconstructed vertex difference motion vectors are output. In other words, when the subgroup difference motion vectors are parsed, the vertex difference motion vector deriver 18016 may derive the vertex difference motion vectors in the current subgroup from the subgroup difference motion vectors. When there is no parsed subgroup difference motion vector, the vertex difference motion vector deriver 18016 may derive the vertex difference motion vector as a zero vector (0,0,0). That is, when the value of the first skip flag information (e.g., mvd_skip_flag) is 0 and the value of the second skip flag information (e.g., vertex_mvd_skip_flag) is 1, the transmission device transmits the difference motion vector of the subgroup but does not transmit the per-vertex difference motion vector. Accordingly, the vertex difference motion vector deriver 18016 derives the per-vertex difference motion vector with the same value as the difference motion vector of the subgroup because the subgroup difference motion vector is parsed while the per-vertex difference motion vector is not parsed.

Next, the parsing of signaling information (e.g., mvd_resolution_idx, mvd_skip_flag, vertex_mvd_skip_flag) performed by the difference motion vector decoder 17011 and/or the subgroup partitioner 15012 will be described.

According to embodiments, motion vector resolution information (mvd_resolution_idx) may be parsed to select a resolution of the difference motion vector. The motion vector resolution information (mvd_resolution_idx) may be referred to as an index for a difference motion vector resolution. In the present disclosure, the resolution of the difference motion vector may be determined by parsing the difference motion vector resolution index on a per-subgroup basis or a per-higher unit (e.g., slice or tile) basis.

According to embodiments, to check whether the (difference) motion vector should be skipped, (difference) motion vector skip flag information (e.g., mvd_skip_flag, vertex_mvd_skip_flag) may be parsed.

According to embodiments, the first skip flag information (e.g., mvd_skip_flag) is a flag used to check whether to skip the (difference) motion vectors of the subgroup and vertices. For example, the (difference) motion vector skip flag (e.g., mvd_skip_flag) of the subgroup is 1, both the (difference) motion vector of the subgroup and the (difference) motion vectors of the vertices may be derived as zero vectors (0,0,0). In other words, deriving the (difference) motion vector as a zero vector (0,0,0) means that the transmission device has not transmitted the (difference) motion vector.

According to embodiments, the second skip flag information (e.g., vertex_mvd_skip_flag) is a flag used to check whether to skip the (difference) motion vector of a vertex. For example, when the skip flag (e.g., vertex_mvd_skip_flag) for the (difference) motion vector of a vertex in a subgroup is 1, the (difference) motion vector of the vertex may be derived as a zero vector (0,0,0). In other words, deriving the (difference) motion vector as a zero vector (0,0,0) means that the transmission device has not transmitted the (difference) motion vector.

Thus, when the value of the first skip flag information (e.g., mvd_skip_flag) is 0 and the value of the second skip flag information (e.g., vertex_mvd_skip_flag) is 1, the difference motion vector of the subgroup is transmitted from the transmission device, but the per-vertex difference motion vector is not transmitted. Therefore, the reception device parses the difference motion vector of the subgroup but does not parse the per-vertex difference motion vector. In this case, the per-vertex difference motion vector is derived to have the same value as the difference motion vector of the subgroup.

In other words, deriving the (difference) motion vector as a zero vector means that the transmission device does not transmit the per-subgroup difference motion vector and/or per-vertex difference motion vector. In this case, the reception device may obtain the predicted motion vector as the reconstructed motion vector.

That is, when the (difference) motion vector is derived as a zero vector, the predicted motion vector becomes the reconstructed motion vector (predicted motion vector (x,y,z)+difference motion vector (0,0,0)=reconstructed motion vector (x,y,z)).

According to embodiments, the decoder in the reception device may decode one or more subgroups on a per-tile or per-slice basis. In addition, decoding may be processed in parallel on a per-tile or per-slice basis because tiles are not dependent on each other.

Further, the decoder of the reception device may support spatial random access on a per-tile or per-slice basis. Further, encoder parameters, such as a motion vector resolution index (e.g., mvd_resolution_idx), a quantization parameter, and the like per partition unit (patch group, subgroup, slice, tile, etc.) may be received from the transmission device.

According to embodiments, the motion vector decoder 15014 may receive the per-subgroup difference motion vector resolution index (mvd_resolution_idx) obtained through parsing and multiply the reconstructed vertex difference motion vectors by the difference motion vector resolution mapped to each index. Here, the difference motion vector resolutions mapped to the difference motion vector resolution indices may be tabulated as shown in FIG. 19 to obtain the resolution values mapped to the indices.

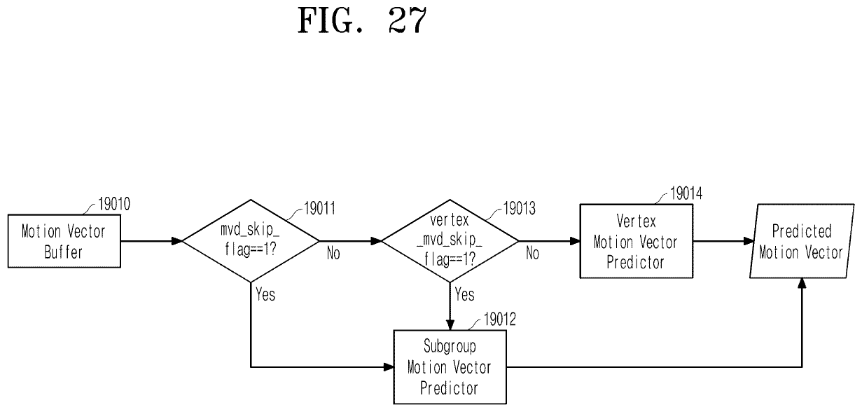

FIG. 27 is a diagram illustrating an exemplary motion vector estimation process according to embodiments. Specifically, FIG. 27 is a diagram illustrating an exemplary process of predicting motion vectors by the motion vector predictor 17014 of FIG. 26. In FIG. 27, the execution order of the blocks may be changed, some blocks may be omitted, and new blocks may be added.

According to embodiments, the motion vector predictor 17014 may first generate a predicted motion vector based on the reconstructed motion vector and then output the same to the motion vector reconstructor 17012. In one embodiment, the reconstructed motion vector may be provided from the motion vector buffer (19011).

According to embodiments, the subgroup motion vector predictor 19012 predicts the per-subgroup motion vector based on at least one of the first skip flag information (e.g., mvd_skip_flag) and the second skip flag information (e.g., vertex_mvd_skip_flag).

For example, the subgroup motion vector predictor 19012 calculates the predicted motion vectors on a per-subgroup basis when the value of the first skip flag information (e.g., vertex_mvd_skip_flag) is 1, or when the value of the first skip flag information (e.g., mvd_skip_flag) is 0 and the value of the second skip flag information (e.g., vertex_mvd_skip_flag) is 1. That is, the subgroup motion vector predictor 19012 may be operated when (mvd_skip_flag==1) or (mvd_skip_flag==0 && vertex_mvd_skip_flag==1). The predicted motion vectors calculated (or acquired) by the subgroup motion vector predictor 19012 are provided to the motion vector reconstructor 17012.

According to embodiments, the subgroup motion vector predictor 19012 may calculate the predicted motion vector of a subgroup based on the motion vectors of previously reconstructed neighbor vertices in the current frame or the motion vectors in the reference frame.

According to embodiments, the predicted motion vector of the subgroup may be obtained through prediction based on the motion vector of a subgroup spatially close to the current subgroup among the subgroups reconstructed earlier, or the average motion vector of the N vertices closest to the vertices of the current subgroup.

According to embodiments, when the reference base mesh is a P-frame or B-frame, the average motion vector of the vertices of the reference base mesh having the same indices as the vertices of the current base mesh may be used as the predicted motion vector of the current subgroup.

When the value of the first skip flag information (e.g., mvd_skip_flag) and the value of the second skip flag information (e.g., vertex_mvd_skip_flag) are both 0, the motion vectors are predicted on a vertex-by-vertex basis by the vertex motion vector predictor 19014, and are provided to the motion vector reconstructor 17012.

That is, the vertex motion vector predictor 19014 calculates the predicted motion vectors on a vertex-by-vertex basis. In other words, when (mvd_skip_flag==0 && vertex_mvd_skip_flag==0), motion vector prediction may be performed on a vertex-by-vertex basis within the current subgroup. In the present disclosure, the predicted motion vectors of the vertices in the subgroup may be calculated based on the previously decoded vertex motion vectors. According to embodiments, prediction may be performed by the average of the motion vectors or parallelogram prediction or the average of multiple parallelogram predictions of adjacent vertices based on connectivity information.

The motion vector predictor 17014 in the present disclosure may be omitted. In this case, the motion vector decoder may reconstruct by parsing the motion vectors, instead of difference motion vectors.

Additionally, in the present disclosure when the difference motion vector is derived as a zero vector (0, 0, 0), i.e., when the difference motion vector is not transmitted, the motion vector predicted by the motion vector predictor 17014 is regarded as the reconstructed motion vector.

Further, based on at least one of the first skip flag information and/or the second skip flag information, the transmission of the subgroup (difference) motion vectors and/or vertex (difference) motion vectors may be skipped. The (difference) motion vectors whose transmission is skipped may be derived as zero vectors by the decoder of the reception device. The first skip flag information may be signaled for each subgroup, and the second skip flag information may be signaled for each vertex in the subgroup. That is, the skip mode may be applied on a subgroup-by-subgroup and/or vertex-by-vertex basis.

For example, when the value of the first skip flag information is 1, the (difference) motion vectors for all vertices in the subgroup may be derived as zero vectors.

Additionally, when the value of the first skip flag information is 0, the (difference) motion vectors may be transmitted on a vertex-by-vertex basis, and the decoder of the reception device may parse and decode the (difference) motion vectors on a vertex-by-vertex basis. In this case, the second skip flag information may be omitted.

In the present disclosure, related information may be signaled to add/carry out embodiments. The signaling information according to the embodiments may be used on the transmitting side or the receiving side. For example, the signaling information according to the embodiments may be generated by the metadata processor (which may be referred to as a metadata generator, not shown) of the transmission device and transmitted, and may be received and acquired by the metadata parser (not shown) of the reception device. The operations of the reception device may be performed based on the signaling information.

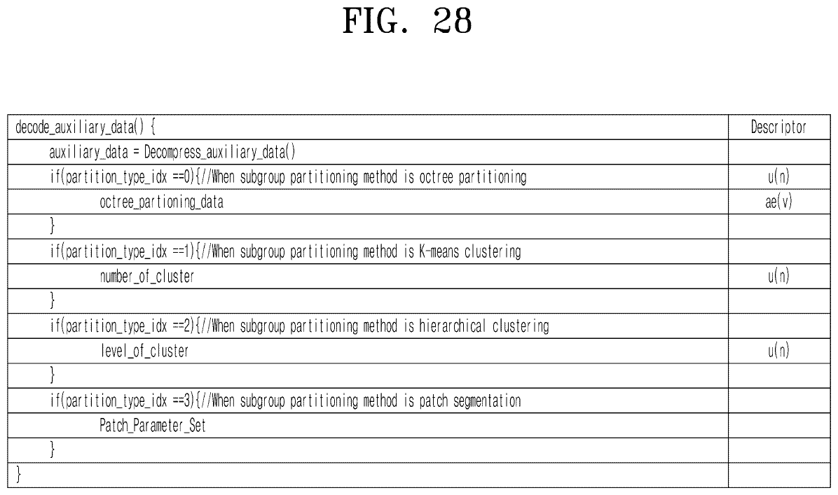

FIG. 28 shows an exemplary syntax structure of subgroup partitioning information according to embodiments.

In one embodiment, the subgroup partitioning information (decode_auxiliary_data( )) in FIG. 28 may be signaled in auxiliary information, particularly an auxiliary information header to be transmitted and received. In one embodiment, the auxiliary information header transmits syntax related to the auxiliary information on a mesh frame-by-mesh frame basis.

According to embodiments, the subgroup partitioning information (decode_auxiliary_data( )) may include information about a subgroup partitioning method according to the subgroup partitioning method (e.g., partition_type_idx).

In other words, partition_type_idx indicates the subgroup partitioning method index, as shown in FIG. 23.

For example, when the value of partition_type_idx is 0, it indicates that the subgroup partitioning method is octree partitioning, and the subgroup partitioning information (decode_auxiliary_data( )) may include partitioning information related to the octree structure (e.g., octree_partitioning_data).

When the value of partition_type_idx is 1, it indicates that the subgroup partitioning method is K-means clustering, and the subgroup partitioning information (decode_auxiliary_data( )) may include information related to the initial number of clusters (e.g., number_of_cluster).

When the value of partition_type_idx is 2, it indicates that the subgroup partitioning method is hierarchical clustering, and the subgroup partitioning information (decode_auxiliary_data( )) may include information related to the cluster level (e.g., level_of_cluster).

When the value of partition_type_idx is 3, it indicates that the subgroup partitioning method is patch segmentation, and the subgroup partitioning information (decode_auxiliary_data( )) may include information related to the patch size (e.g., patch_parameter_set).

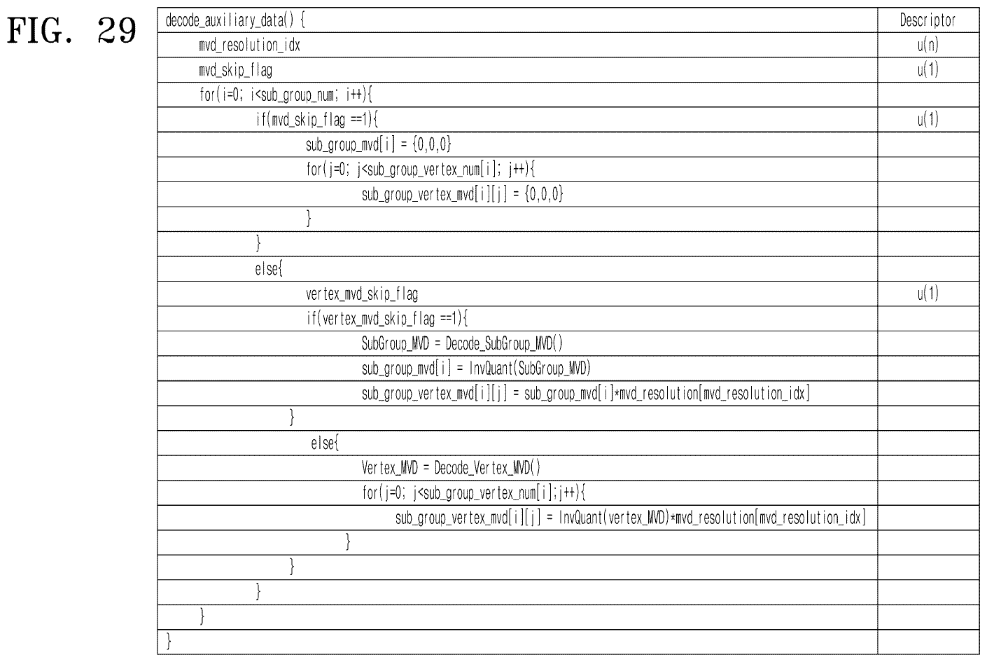

FIG. 29 shows an exemplary syntax structure of motion vector related information according to embodiments.

The motion vector-related information (decode_motion_vector( )) in FIG. 29 may be signaled in the mvd_subgroup_header in the geometry information bitstream so as to be transmitted and received. In one embodiment, the mvd_subgroup_header transmits motion vector related syntax on a subgroup-by-subgroup basis.

According to embodiments, the motion vector related information may include mvd_resolution_idx and mvd_skip_flag.

mvd_resolution_idx indicates an index for the resolution of difference motion vectors, as shown in FIG. 19.

mvd_skip_flag is a difference motion vector skip flag for the subgroups and vertices, which may be referred to as first skip flag information for simplicity.

According to embodiments, the motion vector related information may include mvd_skip_flag followed by a loop that is executed as many times as the number of subgroups.

For example, when the value of mvd_skip_flag for the i-th subgroup is 1, the difference motion vector of the i-th subgroup is derived as a zero vector (0,0,0). The difference motion vector for each vertex included in the i-th subgroup is also derived as a zero vector (0,0,0). In other words, the difference motion vectors of all subgroups and the difference motion vectors of all vertices in each subgroup are derived as zero vectors (0,0,0).

On the other hand, when the value of mvd_skip_flag for the i-th subgroup is not 1, i.e., when it is 0, the motion vector related information may further include vertex_mvd_skip_flag for the i-th subgroup.

vertex_mvd_skip_flag, which is a difference motion vector skip flag for vertices, may be referred to as second skip flag information for simplicity.

For example, when the value of mvd_skip_flag for the i-th subgroup is 0 and the value of vertex_mvd_skip_flag is 1, the (difference) motion vector for the i-th subgroup is derived from the value obtained by inverse quantization of the difference motion vector of the i-th subgroup, and the (difference) motion vector of the j-th vertex in the i-th subgroup is derived from sub_group_mvd[i]*mvd_resolution[mvd_resolution_idx]. In other words, the (difference) motion vector of the j-th vertex in the i-th subgroup may be derived from the (difference) motion vector of the i-th subgroup. In this case, the process of parsing the motion vector resolution index determined per subgroup multiplying the value corresponding to the difference motion vector resolution index of the vertices in the subgroup by the difference motion vector per vertex may be added.

In other words, when the value of vertex_mvd_skip_flag is 1, the motion vector decoder in the reception device may determine that the difference motion vector per vertex is skipped, and then perform decoding, considering the (difference) motion vector of the subgroup as the motion vector of the vertex.

Thereafter, the decoded subgroup difference motion vector is inversely quantized by the subgroup difference motion vector inverse quantizer 18015, and the difference motion vector per vertex is derived from the inversely quantized subgroup difference motion vector by the vertex difference motion vector deriver 18016.

In another example, when the value of mvd_skip_flag for the i-th subgroup is 0 and the value of vertex_mvd_skip_flag is also 0, the (difference) motion vector of the j-th vertex in the i-th subgroup is derived as the motion vector of the vertex (InvQuant (Vertex) MVD)*mvd_resolution[mvd_resolution_idx].

In other words, the motion vector decoder in the reception device may decode the difference motion vector per vertex obtained through parsing. Then, the decoded difference motion vector per vertex may be inversely quantized by the vertex difference motion vector inverse quantizer 18017. In this case, the process of parsing the motion vector resolution index determined per subgroup and multiplying the difference motion vectors of the vertices in the subgroup by a value corresponding to the motion vector resolution index may be performed.

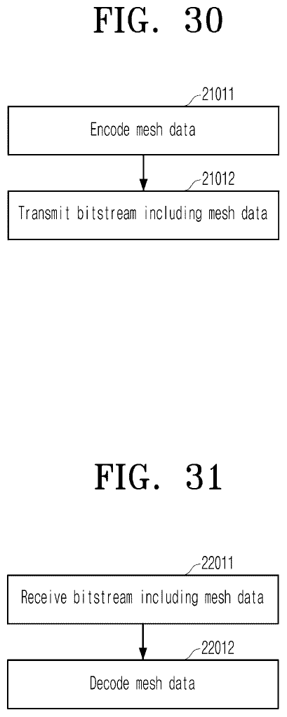

FIG. 30 is a flowchart illustrating an exemplary transmission method according to embodiments. The transmission method according to the embodiments may include encoding mesh data (21011) and transmitting a bitstream containing the encoded mesh data (21012).

According to embodiments, when the encoding is performed through inter-frame prediction, the encoding of the mesh data (21011) may include partitioning reference base mesh into subgroups and encoding (reference) motion vectors on a per-subgroup and/or per-vertex basis. In this case, subgroup partitioning information may be signaled in auxiliary information and transmitted to the receiving side.

According to embodiments, the subgroup partitioning information may include a subgroup partitioning method (e.g., partition_type_idx), and information about the subgroup partitioning method (e.g., initial number of clusters (e.g., number_of_cluster) in the case of K-means clustering, cluster level (e.g., level_of_cluster) in the case of hierarchical clustering, octree structure (e.g., octree_partitioning_data) in the case of octree partitioning, and patch size (e.g., patch_parameter_set) in the case of patch segmentation)). Additionally, the encoding of the mesh data (21011) may include signaling skip flag information (or simply a skip flag) for indicating whether to skip (difference) motion vectors.

For details of the subgroup partitioning methods, encoding of motion vectors on the per-subgroup and/or per-vertex basis, and the subgroup partitioning information and motion vector-related information, which will not be described below to avoid redundancy, reference is made to the description of FIGS. 15 to 20, 28, and 29.

As described above, the reference base mesh may be partitioned into subgroups. When the (difference) motion vectors of vertices in each subgroup are similar to each other, only the difference motion vector of the subgroup may be transmitted, while transmission of the difference motion vector for each vertex may be skipped. Thereby, the amount of data transmitted may be reduced, and thus the compression efficiency of the geometry information may be further improved.

FIG. 31 is a flowchart illustrating an exemplary reception method according to embodiments. The reception method according to the embodiments may include receiving a bitstream containing mesh data (22011) and decoding the mesh data contained in the bitstream (22012).

For details of the receiving of a bitstream containing mesh data (22011) and the decoding of the mesh data contained in the bitstream (22012), which will not be described below to avoid redundancy, reference is made to the detailed description of FIGS. 21 to 29.

As such, the present disclosure may improve the inter (inter-frame prediction) mode technique of V-mesh by allowing encoding and decoding to be performed per subgroup with similar motion vectors in performing inter-frame prediction. In other words, in encoding/decoding geometry information related to 3D dynamic mesh data through inter-frame prediction, the reference base mesh may be partitioned into subgroups based on the motion vectors of similar vertices, and the motion vectors may be calculated for each of the partitioned subgroups to transmit (difference) motion vectors per subgroup. Thereby, the amount of data to be transmitted may be reduced, and the compression efficiency of geometry information may be improved. Particularly, when the motion vectors of vertices in a subgroup are similar, only the difference motion vector per subgroup may be transmitted, and the transmission of difference motion vectors for the vertices may be skipped, thereby reducing the amount of bits to be transmitted or parsed. Additionally, according to the present disclosure, the resolution of motion vectors may be determined on a subgroup-by-subgroup basis.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “ . . . module (or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments of the embodiments have been shown and described, the embodiments are not limited to the specific embodiments described above, and various modifications may be made by one of ordinary skill in the art without departing from the spirit of the embodiments claimed in the claims, and such modifications should not be understood in isolation from the technical ideas or views of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Operations according to the embodiments described in this specification may be performed by a transmission/reception device including one or more memories and/or one or more processors according to embodiments. The one or more memories may store programs for processing/controlling the operations according to the embodiments, and the one or more processors may control various operations described in this specification. The one or more processors may be referred to as a controller or the like. In embodiments, operations may be performed by firmware, software, and/or combinations thereof. The firmware, software, and/or combinations thereof may be stored in the processor or the memory.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise. The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if” and “when” are not limited to an optional case and are intended to be interpreted, when a specific condition is satisfied, to perform the related operation or interpret the related definition according to the specific condition. Embodiments may include variations/modifications within the scope of the claims and their equivalents. It will be apparent to those skilled in the art that various modifications and variations can be made in the present disclosure without departing from the spirit and scope of the disclosure. Thus, it is intended that the present disclosure cover the modifications and variations of this disclosure provided they come within the scope of the appended claims and their equivalents.

### MODE FOR DISCLOSURE

As described above, related contents have been described in the best mode for carrying out the embodiments.

### INDUSTRIAL APPLICABILITY

As described above, the embodiments may be fully or partially applied to the 3D data transmission/reception device and system. It will be apparent to those skilled in the art that various changes or modifications may be made to the embodiments within the scope of the embodiments. Thus, it is intended that the embodiments cover modifications and variations provided they come within the scope of the appended claims and their equivalents.

1. A method of transmitting 3D data, the method comprising:
pre-processing input mesh data and outputting base mesh data;
encoding the base mesh data; and
transmitting a bitstream including the encoded mesh data and signaling information.

2. The method of claim 1, wherein the encoding of the base mesh data comprises:
partitioning reference base mesh data into subgroups;
acquiring a motion vector between the base mesh data and the reference base mesh data for each of the subgroups; and
encoding the acquired motion vector.

3. The method of claim 2, wherein the motion vector is an average of motion vectors of vertices in a corresponding one of the subgroups.

4. The method of claim 2, wherein the signaling information comprises information related to the subgroup partitioning.

5. The method of claim 2, wherein the signaling information further comprises motion vector-related information for indicating whether to skip the motion vector.

6. The method of claim 5, further comprising transmitting the motion vector or skipping the transmission of the motion vector based on the motion vector-related information.

7. The method of claim 6, wherein, based on the transmission of the motion vector being skipped, a zero vector is derived for the motion vector on a receiving side.

8. A device for transmitting 3D data, comprising:
a pre-processor configured to pre-process input mesh data and output base mesh data;
an encoder configured to encode the base mesh data; and
a transmitter configured to transmit a bitstream including the encoded mesh data and signaling information.

9. The device of claim 8, wherein the encoder comprises:
a subgroup partitioner configured to partition reference base mesh data into subgroups;
a motion vector calculator configured to acquire a motion vector between the base mesh data and the reference base mesh data for each of the subgroups; and
an encoding unit configured to entropy-encode the acquired motion vector.

10. The device of claim 9, wherein the motion vector is an average of motion vectors of vertices in a corresponding one of the subgroups.

11. The device of claim 9, wherein the signaling information comprises information related to the subgroup partitioning.

12. The device of claim 11, wherein the signaling information further comprises motion vector-related information for indicating whether to skip the motion vector.

13. The device of claim 11, wherein the motion vector is transmitted or the transmission of the motion vector is skipped based on the motion vector-related information.

14. The device of claim 13, wherein, based on the transmission of the motion vector being skipped, a zero vector is derived for the motion vector on a receiving side.

15. A method of receiving 3D data, the method comprising:
receiving a bitstream containing encoded mesh data and signaling information;
partitioning reference mesh data into subgroups based on the signaling information and decoding the mesh data based on a motion vector for each of the subgroups; and
rendering the decoded mesh data.
